(19) United States
(12) Patent Application Publication
(10) Pub. No.: US 2026/0341785 A1
(43) Pub. Date: Oct. 29, 2026

(54) GEL-LIKE ELECTROLYTE, CURABLE COMPOSITION AND POWER-STORAGE DEVICE

(71) Applicant: TOAGOSEI CO., LTD., Tokyo (JP)

(72) Inventors: Hideki HIRAOKA, Nagoya-shi (JP); Tomoko NAKANO, Nagoya-shi (JP)

(73) Assignee: TOAGOSEI CO., LTD., Tokyo (JP)

(21) Appl. No.: 19/115,625

(22) PCT Filed: Sep. 21, 2023
(86) PCT No.: PCT/JP2023/034265

§ 371 Date: Mar. 26, 2025

(30) Foreign Application Priority Data
Sep. 28, 2022 (JP) 2022-155558

(51) Int. Cl. H01M 10/0565

(52) U.S. Cl. CPC H01M 10/0565; H01M 2300/0082

(57) ABSTRACT

The present invention provides a gel-like electrolyte which is excellent in shape stability and exhibits high ionic conductivity at room temperature. The present invention further provides a curable composition which is excellent in storage stability and is used for producing the gel-like electrolyte. A gel-like electrolyte including: a (meth)acrylic polymer (hereinafter, referred to as “component (A)”) having a structural unit derived from a (meth)acrylic monomer containing a compound having two or more (meth)acryloyl groups; an alkali metal salt (hereinafter, referred to as “component (B)”); and a nonaqueous organic solvent (hereinafter, referred to as “component (C)”), in which a content ratio of the components (A) to (C) with respect to 100 mass % of a total of the components (A) to (C) is 10 to 30 mass % for the component (A), 5 to 40 mass % for the component (B), and 40 to 80 mass % for the component (C).

### TECHNICAL FIELD

The present invention relates to a gel-like electrolyte, a curable composition, and a power storage device.

### BACKGROUND ART

As a secondary battery, various power storage devices such as a nickel-hydride secondary battery, a lithium ion secondary battery, and an electric double layer capacitor have been put into practical use. Among them, a lithium ion secondary battery is used in a wide range of uses in terms of having high energy density and battery capacity. Furthermore, a sodium ion secondary battery and a potassium ion secondary battery are considered to be advantageous in terms of an increase in charging and discharging speed and stable supply of resources, and are studied for next-generation secondary batteries.

A lithium ion secondary battery is a secondary battery that includes a negative electrode, a positive electrode, and an electrolyte, and performs charging and discharging by moving lithium ions between both the electrodes via the electrolyte. An organic electrolytic solution has been mainly used as the electrolyte. On the other hand, in recent years, it has been proposed to use a polymer solid electrolyte (hereinafter, also referred to as “solid electrolyte”) and a polymer gel electrolyte (hereinafter, also referred to as “gel-like electrolyte”) in place of the organic electrolytic solution as a technique for eliminating the concern of liquid leakage of the electrolytic solution and a short circuit inside the battery due to overcharge and overdischarge (see Non-Patent Literature 1).

Among them, it is known that the gel-like electrolyte can prevent accidents such as liquid leakage by holding an organic electrolytic solution (organic solvent) in a polymer compound to suppress fluidity and has higher ionic conductivity than that of a solid electrolyte not using an organic electrolytic solution.

As the polymer compound capable of achieving an ionic conductivity of 1×10'S/cm, which is a target for practical use of a gel-like electrolyte, polyethylene oxide, polyvinylidene fluoride, polyacrylate, and the like have been studied, and some of them have been put to practical use (Non-Patent Literature 1).

Here, it is known that a gel-like electrolyte containing polyacrylate is obtained by radically polymerizing a curable composition containing an organic electrolytic solution and a monomer (acrylate compound) to be a precursor of a polymer (Non-Patent Literature 1), and 2-cyanoethyl acrylate, ditrimethylolpropane tetraacrylate (for example. Example 1 of Patent Literature 1) and polyethylene glycol diacrylate (for example, Patent Literature 2) are studied as the acrylate compound.

### CITATION LIST

### Patent Literature

Patent Literature 1: WO 2015/065004 A
Patent Literature 2: WO 2020/026702 A

### Non-Patent Literature

Non-Patent Literature 1: Polymer Vol. 54, December (2005) issue, p. 870-873

### SUMMARY OF INVENTION

### Problems to be Solved by Invention

When polyethylene oxide or polyvinylidene fluoride is used as the polymer compound constituting the gel-like electrolyte, the electrolytic solution can be held in a gel state even in a small amount, and high conductivity can be easily obtained. However, since the molecular weight is high, it is difficult to penetrate into the electrode active material layer.

On the other hand, polyacrylate can be obtained by pouring a gel precursor solution obtained by mixing an organic electrolytic solution and an acrylate compound as a monomer between the positive electrode and the negative electrode, allowing the solution to penetrate into the electrode active material layer, and then radically polymerizing the solution. However, in this case, when the monomer concentration is low, polymerization is difficult, and gelation may not occur. Conversely, when the monomer concentration is high, gelation is easy, but it is difficult to obtain practical ionic conductivity.

Furthermore, since the polyethylene oxide is easily coordinated to an alkali metal ion, and many applications to a gel-like electrolyte have been studied, a polyethylene glycol diacrylate having an ether structure (polyethylene oxide chain) has also been studied as the acrylate compound (for example, Patent Literature 2).

However, according to the study of the inventors, the compound having an ether structure is easily oxidized by oxygen in the air to become a peroxide, and the decomposition product thereof causes radical polymerization during storage, causing gelation and thickening, which may raise a problem that the storage stability of the curable composition containing the compound is deteriorated.

The present invention has been made in view of such circumstances, and an object thereof is to provide a gel-like electrolyte which is excellent in shape stability and exhibits high ionic conductivity at room temperature. Further, another object of the present invention is to provide a curable composition which is excellent in storage stability and is used for producing the gel-like electrolyte.

As a result of intensive studies to solve the above problems, the present inventors have found that a gel-like electrolyte containing a specific (meth)acrylic polymer, an alkali metal salt, and a nonaqueous organic solvent at a specific ratio has excellent shape stability and exhibits high ionic conductivity at room temperature, thereby completing the present invention.

The present invention is as follows.
[1]A gel-like electrolyte including: a (meth)acrylic polymer (hereinafter, also referred to as “component (A)”) having a structural unit derived from a (meth)acrylic monomer containing a compound having two or more (meth)acryloyl groups; an alkali metal salt (hereinafter, also referred to as “component (B)”); and a nonaqueous organic solvent (hereinafter, also referred to as “component (C)”), in which the content ratio of the components (A) to (C) with respect to 100 mass % of the total of the components (A) to (C) is 10 to 30 mass % for the component (A), 5 to 40 mass % for the component (B), and 40 to 80 mass % for the component (C).
[2] The gel-like electrolyte according to [1], in which the oxygen atom constituting the component (A) does not substantially contain an oxygen atom derived from an ether group.
[3] The gel-like electrolyte according to [1] or [2], in which the oxygen atom constituting the component (C) does not substantially contain an oxygen atom derived from an ether group.
[4] The gel-like electrolyte according to any one of [1] to [3], in which the component (B) contains an alkali metal salt having a disulfonimide structure represented by formula (1) below:

Rf₁—S(═O)₂N⁻S(═O)₂Rf₂M⁺ (1)
(Rf₁ and Rf₂ are the same or different and represent a fluorine atom or a perfluoroalkyl group, the perfluoroalkyl groups may form a cyclic structure with each other by a covalent bond, and M⁺ represents a lithium ion, a sodium ion, or a potassium ion).
[5] The gel-like electrolyte according to any one of [1] to [4], in which the component (C) contains at least one selected from the group consisting of a carbonate compound, an aliphatic ester compound, and a nitrile compound.
[6] The gel-like electrolyte according to any one of [1] to [5], in which the compound having two or more (meth)acryloyl groups contains a compound represented by formula (2) below:

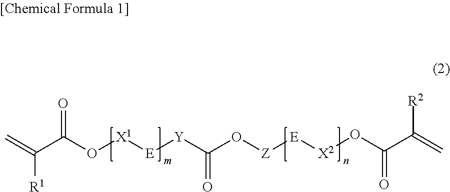

(R¹ and R² each independently represent a hydrogen atom or a methyl group, X¹, X², Y, and Z each independently represent an alkylene group having 2 to 6 carbon atoms which may have a substituent, E represents an ester bond, and m and n each independently represent 0 to 5).
[7] A curable composition used for producing a gel-like electrolyte, the curable composition including:
a (meth)acrylic monomer (hereinafter, also referred to as “component (a)”) containing a compound having two or more (meth)acryloyl groups, component (B), and component (C),
in which the content ratio of the component (a), the component (B), and the component (C) with respect to 100 mass % of the total of the component (a), the component (B), and the component (C) is 10 to 30 mass % for the component (a), 5 to 40 mass % for the component (B), and 40 to 80 mass % for the component (C).
[8] The curable composition according to [7], in which the oxygen atom constituting the component (a) does not substantially contain an oxygen atom derived from an ether group.
[9] The curable composition according to [7] or [8], in which the oxygen atom constituting the component (C) does not substantially contain an oxygen atom derived from an ether group.
[10] The curable composition according to any one of [7] to [9], in which the component (B) contains an alkali metal salt having a disulfonimide structure represented by formula (1) above.
[11] The curable composition according to any one of [7] to [10], in which the component (C) contains at least one selected from the group consisting of a carbonate compound, an aliphatic ester compound, and a nitrile compound.
[12] The curable composition according to any one of [7] to [11], in which the compound having two or more (meth)acryloyl groups includes a compound represented by formula (2) above.
[13] A gel-like electrolyte which is a cured product of the composition according to any one of [7] to [12].
[14] A power storage device including the gel-like electrolyte according to any one of [1] to [6] and [13].

### Effects of Invention

The gel-like electrolyte of the present invention is excellent in shape stability and can exhibit high ionic conductivity at room temperature. Furthermore, according to the curable composition of the present invention, excellent storage stability can be achieved. By using such a gel-like electrolyte of the present invention as an electrolyte of a power storage device such as a secondary battery or a capacitor, it is possible to obtain a power storage device having both ensured safety due to non-fluidization of the electrolyte and battery performance.

### BRIEF DESCRIPTION OF DRAWINGS

FIG. 1 is a diagram illustrating a second charge/discharge curve in a charge/discharge test (Example 56).

FIG. 2 is a diagram illustrating a second charge/discharge curve in a charge/discharge test (Example 57).

### DESCRIPTION OF EMBODIMENTS

Hereinafter, the present invention will be described in detail. In the present specification, “(meth)acryl” means acryl and/or methacryl, and “(meth)acrylate” means acrylate and/or methacrylate. Further, a “(meth)acryloyl group” means an acryloyl group and/or a methacryloyl group.

In the numerical ranges described in stages in the present specification, the upper limit value or the lower limit value described in one numerical range may be replaced with the upper limit value or the lower limit value of a numerical range described in another stage, and the upper limit value or the lower limit value of the numerical range may be replaced with values shown in Examples.

### <<Gel-Like Electrolyte>>

The gel-like electrolyte of the present invention includes a polymer gel electrolyte, and contains components (A), (B), and (C) described below, in which the component (A), the component (B), and the component (C) are 10 to 30 mass %, 5 to 40 mass %, and 40 to 80 mass %, respectively, with respect to 100 mass % of the total of the components (A) to (C).
Component (A): (meth)acrylic polymer having a structural unit derived from a (meth)acrylic monomer containing a compound having two or more (meth)acryloyl groups
Component (B): alkali metal salt
Component (C): nonaqueous organic solvent

### <Component (A): (Meth)Acrylic Polymer>

The content of the component (A) in the polymer gel electrolyte is 10 to 30 mass %, preferably 12 to 25 mass %, and more preferably 12 to 20 mass % with respect to 100 mass % of the total of the components (A) to (C).

The (meth)acrylic polymer (hereinafter, also referred to as “(meth)acrylic polymer (A)”) as the component (A) is suitable in that it has a structural unit derived from a (meth)acrylic monomer (hereinafter, also referred to as “component (a)”) containing a compound (hereinafter, also referred to as “crosslinkable monomer”) having two or more (meth)acryloyl groups, thereby making it possible to obtain a tough gel-like electrolyte membrane, in that it is possible to sufficiently retain a nonaqueous organic solvent, and in that it is possible to stably retain an alkali metal salt in the nonaqueous organic solvent by containing an ester group in the gel-like electrolyte.

The (meth) acrylic polymer (A) only has to be a polymer obtained by polymerizing a (meth)acrylic monomer (component (a)) containing a crosslinkable monomer.

As the crosslinkable monomer, a polyfunctional (meth)acrylate compound having two or more (meth)acryloyl groups can be preferably used. Specific examples of the polyfunctional (meth)acrylate compound include polyol poly(meth)acrylates such as 1,6-hexanediol di(meth)acrylate, diethylene glycol di(meth)acrylate, polyethylene glycol di(meth)acrylate, trimethylolpropane tri(meth)acrylate, glycerin di(meth)acrylate, glycerin tri(meth)acrylate, tri or tetra(meth)acrylate of pentaerythritol, tri or tetra(meth)acrylate of ditrimethylolpropane, tri or tetra(meth)acrylate of diglycerin, and tri, tetra, penta, or hexa(meth)acrylate of dipentaerythritol, oligomers having two or more (meth)acryloyl groups other than the compound represented by formula (2) above, and the like. The crosslinkable monomer constituting the (meth)acrylic polymer (A) may be one kind alone or two or more kinds.

Here, as the crosslinkable monomer, it is preferable that the oxygen atom constituting the crosslinkable monomer does not substantially contain an oxygen atom derived from an ether group in that the storage stability of a curable composition for producing the gel-like electrolyte of the present invention can be improved.

The crosslinkable monomer more preferably contains the compound represented by formula (2) above in that the oxidation resistance of the gel-like electrolyte is high and in that the alkali metal salt can be more stably retained in the nonaqueous organic solvent by having an ester group other than an ester group derived from a (meth)acryloyl group.

The (meth)acrylic polymer (A) may have a structural unit derived from a vinyl-based monomer (hereinafter, also referred to as “vinyl-based monomer M”) other than the structural unit derived from a crosslinkable monomer.

The vinyl-based monomer M is preferably a (meth)acrylic monomer (hereinafter, also referred to as “(meth)acrylic monomer M”) from the viewpoint of easily introducing a structural unit derived from a (meth)acrylic monomer containing an ester group into the side chain of the polymer and industrially easily producing the vinyl-based monomer M. In this case, the reaction rate of the monomer can be easily increased, and the polymer obtained in the polymerization reaction can be used as a gel-like electrolyte as it is without purification.

The proportion of the structural unit derived from the (meth)acrylic monomer M among all the structural units derived from the monomers constituting the (meth)acrylic polymer (A) is preferably more than 50 mass %, more preferably 60 mass % or more, still more preferably 70 mass % or more, even more preferably 80 mass % or more, and still more preferably 90 mass % or more.

Furthermore, the proportion of the acrylic monomer in the (meth)acrylic monomer M constituting the (meth)acrylic polymer (A) is preferably 40 mass % or more, more preferably 50 mass % or more, still more preferably 60 mass % or more, and still more preferably 80 mass % or more. When the proportion of the acrylic monomer is in the above range, it is preferable from the viewpoint that a gel-like electrolyte having higher ionic conductivity can be obtained.

Examples of the (meth)acrylic monomer M include (meth)acrylic acid, a (meth)acrylic acid alkyl ester compound, an alicyclic ester compound of (meth)acrylic acid, an aromatic ester compound of (meth)acrylic acid, a (meth)acrylic compound having a cyclic structure (however, the alicyclic ester compound of (meth)acrylic acid and the aromatic ester compound of (meth)acrylic acid described above are excluded), an alkoxyalkyl (meth)acrylate compound, a hydroxyalkyl (meth)acrylate compound, and a polyalkylene glycol mono(meth)acrylate compound. As the (meth)acrylic monomer M, one kind may be used alone, or two or more kinds may be used in combination.

Here, as the (meth)acrylic monomer M, it is preferable that the oxygen atom constituting the (meth)acrylic monomer M does not substantially contain an oxygen atom derived from an ether group in that the storage stability of the curable composition for producing the gel-like electrolyte of the present invention can be improved.

Among them, the (meth)acrylic acid alkyl ester compound and the (meth)acrylic compound having a cyclic structure are preferable from the viewpoint of increasing ionic conductivity (in particular, ionic conductivity at room temperature).

As the (meth)acrylic acid alkyl ester compound, a (meth)acrylic acid alkyl ester compound having an alkyl group with 1 to 8 carbon atoms is more preferable, and a (meth)acrylic acid alkyl ester compound having an alkyl group with 1 to 4 carbon atoms is still more preferable from the viewpoint of further enhancing ionic conductivity (in particular, ionic conductivity at room temperature).

Specific examples of the (meth)acrylic compound having a cyclic structure include (2-oxo-1,3-dioxolane-4-yl)methyl (meth)acrylate, 2-((2-oxo-1,3-dioxolane-4-yl)methoxy)ethyl (meth)acrylate, 4-vinyl-1,3-dioxolane-2-one, 5-methyl-5-allyloxycarbonyl-1,3-dioxane-2-one, and the like as a monomer having a cyclic carbonate structure;
(2-methyl-2-ethyl-1,3-dioxolane-4-yl)methyl (meth)acrylate, 2-allyloxytetrahydropyran, 2-vinyl-1,3-dioxolane, 4,4,6-trimethyl-2-vinyl-1,3-dioxane, and the like as a monomer having a cyclic ether structure;
oxazolidone (meth)acrylate and the like as a monomer having an oxazolidone ring structure;
1-vinyl-2-pyrrolidone, 1-vinyl-2-pyrrolidinone, N-vinyl-ε-caprolactam, and the like as a monomer having a cyclic amide structure:
2-vinyl-2-oxazoline, isopropenyl-2-oxazoline, and the like as a monomer having an oxazoline ring structure; and
(meth)acryloylmorpholine and the like as a monomer having a morpholine ring structure.

Among them, the cyclic structure in the side chain of the (meth)acrylic polymer (A) is preferably at least one selected from the group consisting of a cyclic carbonate structure, an oxazolidone ring structure, and a cyclic ether structure, more preferably a cyclic carbonate structure and an oxazolidone ring structure, and particularly preferably a cyclic carbonate structure, in that the ionic conductivity (in particular, ionic conductivity at room temperature) can be further increased.

The method for synthesizing the (meth)acrylic monomer M is not particularly limited. Examples of the method for synthesizing the (meth)acrylic monomer M include: a method of subjecting (meth)acrylate and monohydric alcohol to a transesterification reaction in the presence of a nitrogen-containing catalyst X and a zinc-containing catalyst Y (hereinafter, also referred to as “transesterification method T”): a method of reacting acid chloride with alcohol (acid chloride method): a method of reacting (meth)acrylic acid with alcohol using sulfuric acid or sulfonic acids as a catalyst; a method of performing a transesterification reaction using an organotin compound as a catalyst; and a method of performing a transesterification reaction using a titanium compound as a catalyst. Among them, the transesterification method T is preferable in that a monomer having a small content of halogen and impurities derived from a catalyst can be obtained in a high yield. In addition, by producing a solid or gel-like electrolyte using a monomer component with a small mixing amount of halogen, it is possible to suppress battery deterioration due to metal corrosion when the solid or gel-like electrolyte is used as an electrolyte for a lithium secondary battery with a small halogen content in the electrolyte.

In the transesterification method T, examples of the (meth)acrylate include methyl acrylate and 2-methoxyethyl acrylate. As the catalyst X, at least one selected from the group consisting of triethylenediamine, N-methylimidazole, 1,8-diazabicyclo[5,4,0]undeca-7-ene, N,N-dimethyl-4 aminopyridine, and N,N,N′,N′-tetramethyl-1,6-hexanediamine can be preferably used. As the catalyst Y, at least one selected from the group consisting of zinc acetate, zinc acrylate, zinc methacrylate, and zinc acetylacetonate can be preferably used. When the monomer is produced by the transesterification method T, the details of the synthesis conditions can be according to the method described in JP-A-2017-48172.

Here, it is preferable that the oxygen atom constituting the component (A) does not substantially contain an oxygen atom derived from an ether group in that the storage stability of the curable composition for producing the gel-like electrolyte of the present invention can be improved.

The electrolyte used for the secondary battery is preferably a material having high oxidation resistance and reduction resistance and a wide potential window. On the negative electrode side, at the time of initial charge and discharge, a film called SEI is formed on the surface of a negative electrode active material (graphite or the like) by ethylene carbonate and an additive used in an electrolytic solution, and direct contact between the active material and the electrolytic solution is hindered, so that even an organic substance originally having insufficient reduction resistance can withstand practical use. On the other hand, it is considered that a structure having a high degree of oxidation such as an ester group is more advantageous than a compound containing a large amount of ether groups which are easily oxidized since a sufficient effect of oxidation resistance is not obtained as compared with the SEI film.

The proportion of the structural unit derived from the (meth)acrylic monomer M among all the structural units derived from the monomers constituting the (meth)acrylic polymer (A) is preferably 50 mass % or more, more preferably 60 mass % or more, still more preferably 70 mass % or more, and still more preferably 80 mass % or more from the viewpoint of obtaining an electrolyte excellent in ionic conductivity (in particular, ionic conductivity at room temperature). In the (meth)acrylic polymer (A), the upper limit of the proportion of the structural unit derived from the (meth)acrylic monomer M is not particularly limited. From the viewpoint of sufficiently forming a crosslinked structure, the proportion of the structural unit derived from the (meth)acrylic monomer M among all the structural units derived from the monomers constituting the (meth)acrylic polymer (A) is, for example, 99 mass % or less, and preferably 97 mass % or less.

From the viewpoint of sufficiently forming a crosslinked structure and imparting toughness in the case of a film-like electrolyte, the proportion of the structural unit derived from a crosslinkable monomer among all the structural units derived from the monomers constituting the (meth)acrylic polymer (A) is preferably 1 mass % or more, more preferably 10 mass % or more, still more preferably 20 mass % or more, even more preferably 30 mass % or more, even more preferably 40 mass % or more, and even more preferably 50 mass % or more. The upper limit of the proportion of the structural unit derived from a crosslinkable monomer in the (meth)acrylic polymer (A) is preferably 90 mass % or less, more preferably 80 mass % or less, and still more preferably 70 mass % or less with respect to all the structural units derived from the monomers constituting the (meth)acrylic polymer (A) from the viewpoint of ensuring flexibility of the electrolyte.

### <Component (B): Alkali Metal Salt>

The content of the component (B) in the polymer gel electrolyte is 5 to 40 mass %, preferably 8 to 30 mass %, and more preferably 10 to 25 mass % with respect to 100 mass % of the total of the components (A) to (C).

The alkali metal salt as the component (B) is not particularly limited, and examples of the alkali metal constituting the alkali metal salt include lithium, sodium, potassium, rubidium, and cesium, lithium, sodium, and potassium are preferable, and lithium is more preferable.

Examples of the alkali metal salt include: alkali metal salts of fluorosulfonic acid such as LiFSO₃; alkali metal salts of trifluoromethanesulfonic acid such as LiCF₃SO₃; imide-based alkali metal salts such as LiN(FSO₂)₂; alkali metal salts of perfluoroalkanesulfonylmethide such as LiC(CF₃SO₂)₃; fluorophosphates such as LiPFₐ(CₘF₂ₘ₊₁)₆₋ₐ (0≤a≤6, 1≤m≤2); perchloric acid alkali metal salts such as LiClO₄; fluoroborates such as LiBF_{b}(CₙF₂ₙ₊₁)_{4-b} (0≤b≤4, 1≤n≤2); alkali metal salts of oxalatoborate such as LiBOB; cyanoborates such as lithium tetracyanoborate; alkali metal salts such as LiAsF₆, LiI, and LiSbF₆.

Among them, an alkali metal salt having a disulfonimide structure represented by formula (1) below is more preferable in that a gel-like electrolyte having high ionic conductivity at room temperature can be obtained.

Rf₁—S(═O)₂N⁻S(═O)₂Rf₂M⁺ (1)

(Rf₁ and Rf₂ are the same or different and represent a fluorine atom or a perfluoroalkyl group, the perfluoroalkyl groups may form a cyclic structure with each other by a covalent bond, and M⁺ represents a lithium ion, a sodium ion, or a potassium ion).

### <Component (C): Nonaqueous Organic Solvent>

The gel-like electrolyte of the present invention contains a nonaqueous organic solvent which is the component (C). Since the polymer gel electrolyte is in a state in which the polymer component is swollen by the nonaqueous organic solvent, the polymer gel electrolyte is effective for improving safety, for example, in that liquid leakage can be suppressed while the polymer gel electrolyte contains the nonaqueous organic solvent, and in that the volatilization amount of the nonaqueous organic solvent can be reduced.

The content of the component (C) in the polymer gel electrolyte is 40 to 80 mass %, and preferably 50 to 75 mass %, with respect to 100 mass % of the total of the components (A) to (C).

As the component (C), a solvent known as a nonaqueous organic solvent of a polymer gel electrolyte can be appropriately used.

Specific examples of the component (C) include a carbonate compound, an aliphatic ester compound, cyclic esters, a nitrile compound, and an ether compound.

Specific examples of the carbonate compound include ethylene carbonate, propylene carbonate, dimethyl carbonate, ethyl methyl carbonate, diethyl carbonate, vinylene carbonate, and fluoroethylene carbonate.

Examples of the aliphatic ester compound include ethyl acetate, propyl acetate, methyl propionate, ethyl propionate, propyl propionate, dimethyl succinate, diethyl succinate, and dimethyl adipate.

Examples of the cyclic esters include γ-butyrolactone, γ-valerolactone, δ-valerolactone, and ε-caprolactone.

Examples of the nitrile compound include acetonitrile, propionitrile, butyronitrile, valeronitrile, hexanenitnile, isocapronitrile, malononitrile, succinonitrile, adiponitrile, pimelonitrile, and suberonitrile.

Examples of the ether compound include diglyme, triglyme, tetraglyme, crown ether, 1-ethoxy-2-methoxyethane, 1,2-diethoxyethane, tetrahydrofuran, 2-methyltetrahydrofuran, and 1,3-dioxolane.

As the component (C), one kind may be used alone, or two or more kinds may be used in combination.

Among them, it is preferable to contain at least one selected from the group consisting of a carbonate compound, an aliphatic ester compound, and a nitrile compound from the viewpoint of further improving the ionic conductivity of the polymer gel electrolyte.

Here, it is preferable that the oxygen atom constituting the component (C) does not substantially contain an oxygen atom derived from an ether group in that the storage stability of the curable composition for producing the gel-like electrolyte of the present invention can be improved.

### <Other Components>

The gel-like electrolyte of the present invention may contain other components as necessary in addition to the components (A), (B), and (C) described above.

Examples of other components that may be contained in the gel-like electrolyte of the present invention include fillers, leveling agents, and the like in addition to the above components. The content of the other component can be appropriately set according to each compound within a range in which the performance of the electrolyte is not deteriorated, and the total mass ratio of the component (A), the component (B), and the component (C) is preferably 95 mass % or more.

### <<Production of Gel-Like Electrolyte>>

The method for producing the gel-like electrolyte of the present invention is not particularly limited. Examples of the method for producing the gel-like electrolyte of the present invention include the following Methods 1 to 4.

The types and contents of the component (a), the component (B), and the component (C), and the preferred types and ranges of the components are as described above.

[Method 1]A method of curing a curable composition (that is, a curable composition for a gel-like electrolyte) including component (a), component (B), and component (C) described above, in which the content ratio of the component (a), the component (B), and the component (C) with respect to 100 mass % of the total of the component (a), the component (B), and the component (C) is 10 to 30 mass % for the component (a), 5 to 40 mass % for the component (B), and 40 to 80 mass % for the component (C).
[Method 2]A method of swelling 10 to 30 mass % of the component (A) obtained by curing a curable composition containing 10 to 30 mass % of the component (a) with respect to 100 mass % of the total of the component (a), the component (B), and the component (C) described above in a solution in which 5 to 40 mass % of the component (B) is dissolved in 40 to 80 mass % of the component (C).
[Method 3]A method of swelling a mixture of the component (A) and the component (B) obtained by curing a curable composition containing 10 to 30 mass % of the component (a) and 5 to 40 mass % of the component (B) with respect to 100 mass % of the total of the component (a), the component (B), and the component (C) described above in 40 to 80 mass % of the component (C).
[Method 4] A method of applying a polymer composition containing the components (A) to (C) described above and a solvent, in which the content ratio of the components (A) to (C) described above is 10 to 30 mass % for the component (A), 5 to 40 mass % for the component (B), and 40 to 80 mass % of the component (C) with respect to 100 mass % of the total of the components (A) to (C), and evaporating the solvent.

### <Curable Composition for Gel-Like Electrolyte>

The curable composition for a gel-like electrolyte (hereinafter, also simply referred to as “curable composition”) is a curable composition capable of forming a polymer gel electrolyte by, for example, a curing reaction proceeding by heat or an active energy ray. That is, the curable composition may be used as a thermosetting composition or an active energy ray curable composition. Among them, the thermosetting composition is preferable from the viewpoint that the curable composition can be cured in the cell after the electrode is impregnated with the curable composition, and the active energy ray curable composition is preferable from the viewpoint that the curing reaction can easily and sufficiently proceed.

The curable composition of the present invention contains, as a (meth)acrylic monomer to constitute a polymer component of a polymer gel electrolyte together with component (B) that is an alkali metal salt and component (C) that is a nonaqueous organic solvent, component (a) below.

Compound (a): a (meth)acrylic monomer containing a (meth)acrylic monomer containing a compound having two or more (meth)acryloyl groups.

The component (a) only has to be a monomer composition which allows the (meth)acrylic polymer (A) described above to be obtained by curing the curable composition containing the component (a), the component (B), and the component (C). Specifically, the component (a) contains a crosslinkable monomer, and may contain, as necessary, a monomer other than the (meth)acrylic monomer M and the crosslinkable monomer together with the crosslinkable monomer. Examples and preferred examples of the crosslinkable monomer, the (meth)acrylic monomer M, and the monomer other than the crosslinkable monomer include the same compounds as the compounds exemplified as the monomers constituting the (meth)acrylic polymer (A) and the compounds exemplified as the preferred examples. The mass ratios of the crosslinkable monomer and the (meth)acrylic monomer M in the curable composition are equivalent to the mass ratios of the crosslinkable monomer and the (meth)acrylic monomer M with respect to all the structural units of the (meth)acrylic polymer (A). The component (a) may contain only one kind or two or more kinds of (meth)acrylic monomers.

The concentration of the (meth)acryloyl group content in the curable composition of the present invention is preferably 0.5 mol or more, more preferably 0.7 mol or more, and still more preferably 1.2 mol or more, with respect to 1 kg of the total amount of the component (a), the component (B), and the component (C), from the viewpoint of curability of the curable composition and the viewpoint of shape stability of the obtained gel-like electrolyte.

In addition to the components (a), (B), and (C) described above, the curable composition may contain other components as necessary as long as the effects of the present invention are not impaired. Examples of other components include a polymerization initiator and the like in addition to the above-described electrolytic solution.

The polymerization initiator is added to the curable composition together with the component (a) for the purpose of, for example, sufficiently advancing the polymerization reaction. As the polymerization initiator, a known polymerization initiator such as a thermal decomposition type or a photoinitiation type can be used depending on the method for polymerization initiation.

When an electron beam is used as an active energy ray, the polymerization initiator is not always necessary to be blended, but can be blended in a small amount as necessary for improving curability.

Specific examples of the thermal decomposition type polymerization initiator (thermal polymerization initiator) include: organic peroxides such as hydroperoxides, dialkyl peroxides, peroxyesters, peroxydicarbonates, diacyl peroxides, peroxyketals, and ketone peroxides; and azo compounds such as 2,2′-azobisisobutyronitrile, 2,2′-azobis(2,4-dimethylvaleronitrile), 2,2′-azobis(4-methoxy-2,4-dimethylvaleronitrile), dimethyl-2,2′-azobis(2-methylpropionate), and 2,2′-azobis(2-methylbutyronitrile).

Specific examples of the photoinitiation type polymerization initiator (photopolymerization initiator) include benzoin and alkyl ethers thereof, acetophenones, anthraquinones, thioxanthones, ketals, benzophenones, xanthones, acylphosphine oxides, α-diketones, and α-hydroxyketones. A benzoic acid-based or amine-based photosensitizer may be used in combination as necessary in order to improve the sensitivity by irradiation of the active energy ray for obtaining the (meth)acrylic polymer (A).

When the polymerization initiator is blended in the curable composition, the content of the polymerization initiator in the curable composition can be, for example, 0.1 part by mass or more and 15 parts by mass or less with respect to 100 parts by mass of the curable composition. The content of the polymerization initiator is preferably 0.5 part by mass or more, and more preferably 1 part by mass or more, with respect to 100 parts by mass of the total amount of the curable composition, from the viewpoint of sufficiently proceeding the polymerization reaction. The upper limit of the content of the polymerization initiator is preferably 10 parts by mass or less and more preferably 5 parts by mass or less from the viewpoint of appropriately causing gelation in the case of obtaining a polymer gel electrolyte.

In the curable composition, the thermal polymerization initiator and the photopolymerization initiator may be used in combination as the polymerization initiator to produce a gel-like electrolyte by performing a curing reaction with an active energy ray and then performing thermal curing for the purpose of further improving the reaction rate.

The curable composition can be obtained by mixing the above-described components (a), (B), and (C) as well as other components blended as necessary. When the components constituting the curable composition are mixed, the components may be stirred while being heated as necessary. The temperature in the case of stirring and mixing while heating is preferably in the range of 40 to 90 °C. However, when the thermal polymerization initiator is blended in the curable composition, a temperature at which the thermal polymerization initiator does not thermally decompose, for example, 30 °C or lower is preferable in order to suppress the progress of polymerization during the production of the curable composition. Alternatively, it is preferable that after components other than the thermal polymerization initiator are dissolved, the temperature is lowered to a temperature at which sufficient stability is achieved in consideration of the decomposition temperature of each thermal polymerization initiator, and then the thermal polymerization initiator is added and dissolved.

### <Production of Gel-Like Electrolyte by Curable Composition>

The method for producing the gel-like electrolyte using the curable composition is not particularly limited.

For example, a polymer gel electrolyte can be produced by applying the curable composition of the present invention to a substrate or an electrode (positive electrode and negative electrode), and then performing one or both of irradiation of an active energy ray and application of heat to cure the curable composition applied to the substrate or the electrode (positive electrode and negative electrode).

The substrate can be appropriately selected according to the use, and among them, a resin film can be preferably used. Examples of the resin material constituting the resin film include polyester-based resins (for example, polyethylene terephthalate (PET)), polyethersulfone-based resins, acetate-based resins, polycarbonate-based resins, and polyolefin-based resins. The coating surface of the substrate to be coated with the curable composition may be subjected to a peeling treatment. Examples of the peeling treatment include a silicone treatment, a long-chain alkyl treatment, and a fluorine treatment. By using the substrate having the coating surface subjected to the peeling treatment, the gel-like electrolyte formed on the coating surface can be easily peeled off from the substrate.

For example, a polymer gel electrolyte can be produced by injecting a curable composition containing the curable composition of the present invention, a thermal polymerization initiator, and if necessary, an additive for forming SEI such as vinylene carbonate or fluoroethylene carbonate into a pouch cell incorporating a positive electrode, a negative electrode, and a separator, and then thermally curing the curable composition.

For example, a separator (porous film) may be impregnated with a curable composition, sandwiched between films such as PET films as necessary, and irradiated by an active energy ray to polymerize the composition, and then the film may be removed to form a gel-like electrolyte between electrodes.

Examples of the material of the separator include polyethylene (PE) (especially, ultrahigh molecular weight polyethylene is preferable), polypropylene (PP), polyimide, and glass nonwoven fabric.

The coating method can be appropriately set according to the object to be coated and the purpose. Examples of the coating method include coating methods such as a bar coater, an applicator, a doctor blade, a dip coater, a roll coater, a spin coater, a flow coater, a knife coater, a comma coater, a reverse coater, a die coater, a lip coater, a gravure coater, a micro-gravure coater, and an inkjet. The coating amount of the curable composition can be appropriately selected according to the intended use and the like such that the film thickness of the cured product obtained by irradiation of an active energy ray falls within a desired range.

When the curing reaction is performed by irradiation of an active energy ray, examples of the active energy ray by which the curable composition is irradiated include an ultraviolet ray, a visible ray, an electron beam, and the like. Among them, an ultraviolet ray or an electron beam is preferable. The aspect of irradiating the curable composition applied to the substrate or the electrode with active energy is not particularly limited. For example, when the curable composition is applied to a substrate, irradiation of active energy may be performed on only one surface or both surfaces of the substrate coated with the curable composition. The irradiation energy can be appropriately set according to the type of an active energy ray, the compounding composition of the curable composition, and the like.

Specifically, when an ultraviolet ray is used as an active energy ray, the wavelength thereof is, for example, 250 to 400 nm. Examples of the ultraviolet irradiation device include a high-pressure mercury lamp, a metal halide lamp, an ultraviolet non-electrode lamp, and an ultraviolet light emitting diode (UV-LED). The integrated light amount is preferably 500 mJ/cm² or more, more preferably 1,000 mJ/cm² or more, and still more preferably 1,500 mJ/cm² or more. The upper limit of the integrated light amount is preferably 25,000 mJ/cm² or less, and more preferably 20,000 mJ/cm² or less from the viewpoint of suppressing the influence on each component in the curable composition as much as possible and from the viewpoint of energy reduction.

The illuminance and the irradiation time of the ultraviolet ray can be appropriately set such that the integrated light amount becomes a desired amount. For example, the illuminance is preferably 0.5 mW/cm² or more, more preferably 1.0 mW/cm² or more, and still more preferably 2.0 mW/cm² or more. The upper limit of the illuminance is preferably 100 mW/cm² or less, more preferably 80 mW/cm² or less, and still more preferably 50 mW/cm² or less.

In a case where an electron beam is used as the active energy ray, the electron beam irradiation device is not particularly limited, and examples thereof include a Cockcroft-Walton type device, a van der Waals type device, and a resonance transformer type device. The absorbed dose of the electron beam is preferably 1 to 200 kGy, and more preferably 10 to 100 kGy. The acceleration voltage of the electron beam may be appropriately set in a range of 80 to 300 kV according to the thickness of an object to be coated such as a substrate. The oxygen concentration in the electron beam irradiation atmosphere is preferably 500 ppm or less, and more preferably 300 ppm or less.

When the thermosetting reaction is allowed to proceed after the curable composition is injected into the cell, the heating temperature for thermal curing is preferably 30 to 120 °C and preferably 40 to 80 °C from the viewpoint of heat resistance of the pouch cell material. The heating time for thermal curing can be appropriately set according to the type of the polymerization initiator and the like.

When a gel-like electrolyte membrane is obtained from the curable composition of the present invention, the thickness thereof can be appropriately set according to the use and the like. The film thickness of the gel-like electrolyte is, for example, 2 μm or more and 100 μm or less, and preferably 5 μm or more and 70 μm or less.

### <Polymer Composition>

The polymer composition used in method 4 can be obtained by dissolving or dispersing the components (A) to (C) in a solvent. As the solvent, an organic solvent that is more volatile than the component (C) can be preferably used. Specific examples of the organic solvent include aprotic polar solvents, phenolic solvents, alcohol-based solvents, ester-based solvents, ketone-based solvents, ether-based solvents, and hydrocarbon-based solvents. The organic solvent may be one of these solvents, or may be a mixed solvent of two or more thereof. When a polymer gel electrolyte is produced, an electrolytic solution may be used as at least a part of the solvent.

The method for producing the (meth)acrylic polymer (A) to be blended in the polymer composition is not particularly limited. For example, the (meth)acrylic polymer (A) may be produced by polymerizing a monomer component containing a crosslinkable monomer by employing a known polymerization method such as a solution polymerization method, a suspension polymerization method, an emulsion polymerization method, or bulk polymerization. Alternatively, the (meth)acrylic polymer (A) may be produced by curing a mixture of a monomer component containing a crosslinkable monomer and a polymerization initiator with heat or an active energy ray.

In order to produce the polymer gel electrolyte using the polymer composition, the polymer composition can be first applied to a substrate or an electrode (positive electrode and negative electrode) by a known coating method, and the solvent can be removed by a drying treatment such as heating or decompression, thereby to form the polymer gel electrolyte on the substrate or the electrode. When the component (C) is entirely or partially removed by volatilization in the step of removing the solvent, the polymer gel electrolyte may be impregnated with the removed mass of the component (C).

In addition, a polymer gel electrolyte can be produced by a method of gelling a sol-like polymer composition further containing an electrolytic solution, or the like.

### <<Characteristics of Gel-Like Electrolyte>>

The gel-like electrolyte of the present invention exhibits sufficient ionic conductivity even at room temperature (25 °C). Specifically, the ionic conductivity of the gel-like electrolyte at 25 °C is preferably 5.0×10⁻⁴ S/cm or more, more preferably 1.0×10⁻³ S/cm or more, still more preferably 2.0×10⁼³ S/cm or more, still more preferably 3.0×10⁻³ S/cm or more, still more preferably 5.0×10⁻³ S/cm or more, and still more preferably 6.0×10⁻³ S/cm or more. In the present specification, the ionic conductivity of the gel-like electrolyte is a value calculated by sandwiching the gel-like electrolyte between a pair of stainless plates and measuring the impedance between the stainless plates. The details of the method for measuring the ionic conductivity are according to the description of Examples described later.

### <<Power Storage Device>>

The power storage device (hereinafter, also referred to as “the present device”) of the present disclosure includes the present gel-like electrolyte. Examples of the device include a secondary battery and a capacitor. When the present device is a secondary battery, one aspect thereof is a gel battery, and a lithium ion secondary battery, a sodium ion secondary battery, or a potassium ion secondary battery is preferable from the viewpoint of excellent ionic conductivity.

The device may also be a capacitor. One aspect of the capacitor is a configuration including an anode body, a cathode body, and the present gel-like electrolyte, in which the present gel-like electrolyte is disposed between the anode body and the cathode body such that the solid electrolyte and the electrode are in contact with each other.

The power storage device including the present gel-like electrolyte can be applied to various uses. Specifically, the power storage device can be used as a power source in, for example, various mobile devices such as a mobile phone, a personal computer, a smartphone, a game device, and a wearable terminal, various mobile bodies such as an electric vehicle, a hybrid vehicle, a robot, and a drone, and various electric and electronic devices such as a digital camera, a video camera, a music player, a power tool, and a home appliance.

### EXAMPLES

Hereinafter, the present invention will be specifically described based on Examples. Note that the present invention is not limited to these Examples. In the following description, “parts” and “%” respectively mean “parts by mass” and “mass %” unless otherwise specified.

### 1. Synthesis of (Meth)Acrylic Monomer

### <Abbreviations of Compounds Used in Synthesis>

Abbreviations in synthesis examples represent the following compounds.
C-1: 2-methoxyethyl acrylate (Acrycs (registered trademark) C-1 manufactured by Toagosei Co., Ltd.)
MEL: 2-methoxyethanol
DABCO: triethylenediamine
MEHQ: hydroquinone monomethyl ether
TEMPOL: 4-hydroxy-2,2,6,6-tetramethylpiperidine-1-oxyl
DEHA: N,N-diethylhvdroxylamine

### Synthesis Example 1: Synthesis of GCA by transesterification method

Into a 3 liter flask equipped with a stirrer, a thermometer, a gas introduction tube, a fractionating column, and a cooling tube, 660.00 parts (5.59 mol) of glycerin carbonate, 1891.10 parts (14.53 mol) of C-1, 1.22 parts (0.011 mol) of DABCO as a catalyst X, 4.52 parts (0.022 mol) of zinc acrylate as a catalyst Y, 1.02 parts (474 ppm with respect to the total mass of the charged raw materials) of MEHQ, and 0.74 part (288 pm with respect to the total mass of the charged raw materials) of TEMPOL were charged, and an oxygen-containing gas (5 vol % of oxygen and 95 vol % of nitrogen) was bubbled into the liquid.

The pressure in the reaction system was adjusted to a range of 140 to 180 mmHg while heating and stirring the reaction liquid at a temperature of 110 to 120 °C, and the mixed liquid of MEL and C-1 by-produced as the transesterification reaction progressed was extracted from the reaction system via the fractionating column and the cooling tube. The same parts by mass of C-1 as the extraction liquid was added to the reaction system as needed. In addition, C-1 containing MEHQ and TEMPOL was added to the reaction system as needed via the fractionating column. After 17 hours from the start of heating and stirring, heating was terminated, the pressure in the reaction system was returned to normal pressure, and extraction was terminated. As a result of collecting a part of the reaction liquid and performing composition analysis using HPLC, it was confirmed that the reaction liquid contained (2-oxo-1,3-dioxolane-4-yl) methyl acrylate as a target product.

To the filtrate was added 54 parts of aluminum silicate [KYOWAAD 700 (trade name) manufactured by Kyowa Chemical Industry Co., Ltd.] as an adsorbent, and the mixture was heated and stirred at an internal temperature of 80 to 105 °C under normal pressure for 1 hour for contact treatment. Then, 3.0 parts of calcium hydroxide was added at an internal temperature of 20 to 40 °C, and the mixture was stirred at normal pressure for 1 hour. Insolubles were separated by pressurized filtration, and then distillation under reduced pressure was performed for 16 hours in a range of a temperature of 70 to 90 °C and a pressure of 0.001 to 100 mmHg while dry air was bubbled into the filtrate to separate unreacted distillate containing C-1.

To the obtained pot liquid, 0.87 part of DEHA (900 ppm with respect to the material treated in the second step) was added, and the resulting mixture was stirred at an internal temperature in a range of 70 to 90 °C under normal pressure for 3 hours. Thereafter, 4.50 parts of diatomaceous earth [Radiolite (trade name) manufactured by Showa Chemical Industry Co., Ltd.] was added to the pot liquid, and the resulting filtrate was subjected to pressurized filtration to obtain a purified product (hereinafter, also referred to as “GCA”). The mass of the filtrate was 945.75 parts, and the viscosity at 25 °C was 59 mPa-s.

As a result of performing composition analysis using HPLC, it was confirmed that the filtrate contained (2-oxo-1,3-dioxolane-4-yl) methyl acrylate as a target product. As a result of GC analysis, 90 area % of (2-oxo-1,3-dioxolane-4-yl) methyl acrylate was contained.

According to gel permeation chromatography (GPC) analysis of the filtrate, the area ratio of (2-oxo-1,3-dioxolane-4-yl) methyl acrylate and a crosslinkable monomer was 90.05/9.95. The crosslinkable monomer contained glycerin diacrylate, glycerin triacrylate, and an oligomer component having two or more acryloyl groups, and the area ratio thereof was 0.03/6.74/3.18.

### <Measurement Conditions of Viscosity>

The viscosity at 25 °C was measured using an E type viscometer (cone-plate type viscometer).

### <Measurement Conditions of High Performance Liquid Chromatography (HPLC) Analysis>

Apparatus: ACQUITY UPLC manufactured by Waters Corporation
Detector: UV detector
Detection wavelength: 210 nm
Column: ACQUITY UPLC BEH C18 (Part No. 186002350, column inner diameter: 2.1 mm, column length: 50 mm) manufactured by Waters Corporation
Column temperature: 40 °C
Composition of eluent: mixed solution of 0.03 mass % trifluoroacetic acid aqueous solution and methanol
Flow rate of eluent: 0.3 mL/min

### <Measurement Conditions of Gas Chromatography (GC) Analysis>

Apparatus: GC-14B manufactured by Shimadzu Corporation
Detector: FID detector
Column: ZB-1 (length: 60 m, inner diameter: 0.32 mm, film thickness: 3 μm)
Injection temperature: 230 °C or 270 °C
Detector temperature: 330 °C
Column temperature: Kept at 125 °C for 5 minutes, then heated at a rate of 10 °C/min. Kept for 20 minutes after reaching 325 °C
Carrier gas: nitrogen
Injecting amount: 0.4 μL after dilution to 10 mass % with methanol or acetone
Method for calculating purity (%)

Of the peaks detected by GC measurement, the total area of all peaks derived from the sample before dilution was set to 100% without considering the peak derived from the diluent solvent, and the purity was calculated from the peak area of the target product based on mathematical formula (4) below. When each peak was not completely separated, the area of each peak was determined by vertical partitioning.

Purity (%) of target product=(I/S)×100 (4)

Symbols and terms in mathematical formula (4) mean the following.
S: total area of detection peaks derived from sample before solvent dilution
I: peak area of target product

### <Measurement Conditions of Gel Permeation Chromatography (GPC) Analysis>

Apparatus: GPC system name 1515 2414 717P RI manufactured by Waters Corporation
Detector: RI detector
Column, guard column, Shodex KFG (8 μm, 4.6×10 mm) manufactured by Showa Denko K.K., two types of present columns; styragel H 4E THF (7.8×300 mm)+styragel HR 1THF (7.8×300 mm) manufactured by Waters Corporation
Column temperature: 40 °C
Eluent composition: THF (containing 0.03% sulfur as an internal standard), flow rate: 0.75 mL/min
Calibration curve: a calibration curve was generated using standard polystyrene.

### 2. Production and Evaluation of Gel-Like Electrolyte

In the following examples, measurement of the reaction rate of the acrylic monomer, measurement of the ionic conductivity of the gel-like electrolyte, evaluation of the shape stability of the gel-like electrolyte, and evaluation of the storage stability of the curable composition were performed by the following methods.

### <Measurement of Reaction Rate of Acrylic Monomer>

The reaction rate of the acrylic monomer by active energy ray curing or thermal curing was determined by measurement by a micro ATR method using an infrared absorption spectrum measuring apparatus (Spectrum 10 manufactured by Perkin Elmer Japan Co., Ltd.). Specifically, the reaction rate of the acryloyl group was calculated by mathematical formula (1) below using the obtained infrared absorption spectrum.

Reaction rate of acryloyl group={1−(B₂/A₂)/(B₁/A₁)}×100 (1)
A₁: peak height of 1730 cm⁻¹ derived from “—C═O” of curable composition
B₁: peak height of 810 cm⁻¹ derived from “—CH═CH₂” of curable composition
A₂: peak height of 1730 cm⁻¹ derived from “—C═O” of cured product
B₂: peak height of 810 cm⁻¹ derived from “—CH═CH₂” of cured product

### <Measurement of Ionic Conductivity>

The gel-like electrolyte (a circle having a diameter of 6 mm) obtained by the following production was sandwiched between two stainless plates as an electrode, and the impedance between the stainless plates was measured at 25 °C

Measurement was performed by an AC impedance method of applying an alternating current (applied voltage: 10 mV) between the electrodes to measure a resistance component, and the ionic conductivity was calculated from the real impedance intercept of the obtained Cole-Cole plot. An impedance analyzer (E4990A manufactured by Keysight Corporation) was used for the measurement.

All the above operations were performed in a dry room at a dew point of −60 °C

The ionic conductivity (a) was determined by mathematical formula (2) below.

α=L/(R×S) (2)

(in mathematical formula (2), a represents an ionic conductivity (unit: S-cm⁻¹), R represents a resistance (unit: Ω), S represents a cross-sectional area (unit: cm²) at the time of measurement of the gel-like electrolyte membrane, and L represents an inter-electrode distance (unit: cm))

### <Evaluation of Shape Stability>

The shape stability of the gel-like electrolyte was evaluated based on the following criteria.
Good: After cured, the curable composition maintains a disk shape even when the mold made of silicone rubber is removed, and does not flow when peeled off by a spatula.
Fair: After cured, the curable composition had maintained a disk shape even when the mold made of silicone rubber was removed, but only increased in viscosity and flowed when applied with a force by a spatula.
Poor: After cured, the curable composition did not maintain a disk shape and flowed when the mold made of silicone rubber was removed.
Very poor: After the curable composition was cured, crystals of the alkali metal salt precipitated inside the cured product.

### <Evaluation of Storage Stability of Curable Composition>

The curable composition (10 g) for a gel-like electrolyte obtained by the following production was put in a 20 ml vial and stored for 30 days in a thermostatic chamber whose inside was kept at 40 °C The change in the inside was visually confirmed, and the storage stability of the curable composition was evaluated based on the following criteria.
Good: After the storage period, no increase in viscosity was confirmed by visual judgment.
Fair: Obviously thickened after the storage period.
Poor: Gelled after the storage period.

### (1) Production of Gel-Like Electrolyte Using Curable Composition (Method 1)

In the following Examples, a liquid component subjected to a dehydration treatment with a molecular sieve was used.

### Example 1

(A) A 1:1 (mass ratio) mixture (16.5 g) of (2-oxo-1,3-dioxolane-4-yl) methyl acrylate acrylate (GCA described above) and a hydroxypivalic acid neopentyl glycol acrylic acid adduct (Light Acrylate HPP-A manufactured by Kyoeisha Chemical Co., Ltd.) as the component (A), lithium bisfluorosulfonylimide (21.5 g) as the component (B), and propylene carbonate (62.0 g) as the component (C) were weighed in a vial, and stirred and mixed using a heating type stirrer at 60 °C until all the components were uniformly dissolved.

Thereafter, the mixture was cooled to room temperature, 2-hydroxy-2-methylpropiophenone (manufactured by Tokyo Chemical Industry Co., Ltd.: hereinafter, also referred to as “HMP”) (0.83 g) as a photopolymerization initiator was added thereto, and the mixture was stirred and mixed until it became uniform, thereby obtaining a curable composition for a gel-like electrolyte. The evaluation result of the storage stability of the curable composition was Good.

Next, a mold having a circular hole with a diameter of 6 mm made in a silicone rubber sheet (thickness: 0.3 mm) was bonded to a stainless plate (1 cm×1 cm×1 mm), and the curable composition for a gel-like electrolyte was poured into the hole portion.

Further, a release PET film (thickness: 35 μm) of a light peeling type was superposed on the hole so as not to allow air bubbles to enter. The hole was sandwiched between glass plates having a thickness of 1 mm from above and below, and the whole was fixed with clips.

Subsequently, the release PET film was irradiated by an ultraviolet ray having a wavelength of 365 nm (illuminance: 60 mW/cm²) for 360 seconds (integrated light amount: 21.6 J/cm²) using an ultraviolet irradiation device (ultraviolet curing apparatus manufactured by SAN-EI ELECTRIC CO., LTD., mercury xenon lamp, lamp height: 10 mm) to obtain a gel-like solid electrolyte (thickness: 300 μm) as an active energy ray cured product.

For the measurement of illuminance, an ultraviolet integrated light amount meter (UV Power Puckle II (central wavelength of light receiving unit: 355 nm) manufactured by EIT) was used. The reaction rate of the component (a) was >96%.

Finally, the glass plates, the PET film, and the silicone rubber were removed to obtain a test piece in which the gel-like electrolyte was formed in a circular shape on the stainless plate.

In order to suppress moisture absorption, all the operations other than the measurement of the reaction rate of the acrylic monomer among the above operations were performed in a dry room having a dew point of −60 °C

As a result of measuring the ionic conductivity of the obtained gel-like electrolyte, the ionic conductivity was 2.6×10⁻³ S/cm, and the shape stability was Good.

### Examples 2 to 15 and 21 to 55 and Comparative Examples 1 to 10 and 13 to 39

A gel-like electrolyte was obtained by performing the same operation as in Example 1 except that a curable composition for a gel-like electrolyte was prepared by changing the types and charged amounts of raw materials as described in Table 1, Table 2, and Tables 4 to 9. The reaction rate of the component (a) was >96%.

The evaluation results of the storage stability of the curable composition, the measurement results of the ionic conductivity of the gel-like electrolyte, and the evaluation results of the shape stability are shown in Table 1, Table 2, and Tables 4 to 9.

### Examples 16 to 20 and Comparative Examples 11 and 12

A gel-like electrolyte was obtained by performing the same operation as in Example 1 except that a curable composition for a gel-like electrolyte was prepared by changing the types and charged amounts of raw materials as described in Table 3, and the composition was irradiated by an ultraviolet ray having a wavelength of 365 nm (illuminance: 60 mW/cm²) for 60 seconds (integrated light amount: 3,600 mJ/cm²). The reaction rate of the component (a) was >96%.

The evaluation results of the storage stability of the curable composition, the measurement results of the ionic conductivity of the gel-like electrolyte, and the evaluation results of the shape stability are shown in Table 3.

TABLE 1

| | | | | Example | Example | Example | Example | Example | Example | Example |
|---|---|---|---|---|---|---|---|---|---|---|
| Example and Comparative Example Nos. | | | | 1 | 2 | 3 | 4 | 5 | 6 | 7 |
| Curable | Component | (Meth)acrylic | GCA | 8.25 | 7.5 | 7.5 | 9.0 | 10.0 | 10.0 | 10.0 |
| composition | (a) | monomer | BA | | | | | | | |
| for gel-like | | (parts) | HPP-A | 8.25 | 7.5 | 7.5 | 9.0 | 10.0 | 10.0 | 10.0 |
| electrolyte | | Total amount of | | 16.5 | 15.0 | 15.0 | 18.0 | 20.0 | 20.0 | 20.0 |
| | | component (a) (parts) | | | | | | | | |
| | Component | Alkali metal salt | LiFSI | 21.5 | 23.0 | 20.0 | 20.0 | 15.0 | 10.0 | 20.0 |
| | (B) | (parts) | LiTFSI | | | | | | | |
| | Component | Nonaqueous | PC | 62.0 | 62.0 | 65.0 | 62.0 | 65.0 | 70.0 | 60.0 |
| | (C) | organic | | | | | | | | |
| | | solvent | | | | | | | | |
| | | (parts) | | | | | | | | |
| | Other | Photopolymerization | HMP | 0.83 | 0.75 | 0.75 | 0.90 | 1.00 | 1.00 | 1.00 |
| | component | initiator | | | | | | | | |
| | | (parts) | | | | | | | | |
| | Molar concentration of | | | 1.01 | 0.92 | 0.92 | 1.10 | 1.22 | 1.22 | 1.22 |
| | (meth)acryloyl group (mol/kg) | | | | | | | | | |
| | Storage stability | | | Good | Good | Good | Good | Good | Good | Good |
| Evaluation | Ionic conductivity @25 °C | | S/cm | 2.6E−03 | 5.1E−04 | 4.3E−03 | 2.6E−03 | 1.5E−03 | 3.1E−03 | 5.8E−04 |
| results | Shape stability | | | Good | Good | Good | Good | Good | Good | Good |
| (electrolyte) | | | | | | | | | | |

| | | | | | | | | Comparative | Comparative | Comparative |
|---|---|---|---|---|---|---|---|---|---|---|
| | | | | Example | Example | Example | Example | Example | Example | Example |
| Example and Comparative Example Nos. | | | | 8 | 9 | 10 | 11 | 1 | 2 | 3 |
| Curable | Component | (Meth)acrylic | GCA | | 6.25 | 8.25 | 6.25 | | | |
| composition | (a) | monomer | BA | 7.5 | | | | 2.5 | | 0.75 |
| for gel-like | | (parts) | HPP-A | 7.5 | 6.25 | 8.25 | 6.25 | 2.5 | 3.0 | 2.25 |
| electrolyte | | Total amount of | | 15.0 | 12.5 | 16.5 | 12.5 | 5.0 | 3.0 | 3.0 |
| | | component (a) (parts) | | | | | | | | |
| | Component | Alkali metal salt | LiFSI | 15.0 | 15.5 | | | 20.0 | 20.0 | 20.0 |
| | (B) | (parts) | LiTFSI | | | 25.5 | 26.0 | | | |
| | Component | Nonaqueous | PC | 70.0 | 72.0 | 58.0 | 61.5 | 75.0 | 77.0 | 77.0 |
| | (C) | organic | | | | | | | | |
| | | solvent | | | | | | | | |
| | | (parts) | | | | | | | | |
| | Other | Photopolymerization | HMP | 0.38 | 0.63 | 0.83 | 0.63 | 0.25 | 0.16 | 0.15 |
| | component | initiator | | | | | | | | |
| | | (parts) | | | | | | | | |

| | | | | | | | | | |
|---|---|---|---|---|---|---|---|---|---|
| | Molar concentration of | | 0.48 | 0.76 | 1.01 | 0.76 | 0.36 | 0.19 | 0.20 |
| | (meth)acryloyl group (mol/kg) | | | | | | | | |
| | Storage stability | | Good | Good | Good | Good | Good | Good | Good |
| Evaluation | Ionic conductivity @25 °C | S/cm | 4.3E−03 | 6.2E−04 | 5.9E−04 | 1.3E−03 | Unmea- | Unmea- | Unmea- |
| results | | | | | | | surable | surable | surable |

| | | | | | | | | |
|---|---|---|---|---|---|---|---|---|
| (electrolyte) | Shape stability | Good | Good | Good | Good | Poor | Poor | Poor |

TABLE 2

| | | | | Example | Example | Example | Example | Comparative | Comparative |
|---|---|---|---|---|---|---|---|---|---|
| Example and Comparative Example Nos. | | | | 12 | 13 | 14 | 15 | Example 4 | Example 5 |
| Curable | Component | (Meth)acrylic | BA | 14.9 | 7.5 | 7.7 | 11.9 | 15.9 | 4.4 |
| composition | (a) | monomer (parts) | HPP-A | 14.9 | 7.5 | 7.7 | 11.9 | 15.9 | 4.4 |
| for gel-like | | Total amount of | | 29.9 | 15.0 | 15.4 | 23.8 | 31.8 | 8.9 |
| electrolyte | | component (a) (parts) | | | | | | | |
| | Component | Alkali metal salt | LiFSI | 19.4 | 15.0 | 34.1 | 28.8 | 12.2 | 30.1 |
| | (B) | (parts) | | | | | | | |
| | Component | Nonaqueous organic | EC | 25.4 | 35.0 | 25.3 | 23.7 | 28.0 | 30.5 |
| | (C) | solvent | DEC | 25.4 | 35.0 | 25.3 | 23.7 | 28.0 | 30.5 |
| | | (parts) | | | | | | | |
| | | Total amount of | | 50.7 | 70.0 | 50.5 | 47.4 | 56.0 | 61.0 |
| | | component (C) (parts) | | | | | | | |
| | Other | Photopolymerization | HMP | 1.49 | 0.75 | 0.77 | 1.19 | 1.59 | 0.44 |
| | component | initiator | | | | | | | |
| | | (parts) | | | | | | | |
| | Molar concentration of | | | 2.12 | 1.07 | 1.09 | 1.69 | 2.26 | 0.63 |
| | (meth)acryloyl group (mol/kg) | | | | | | | | |
| | Storage stability | | | Good | Good | Good | Good | Good | Good |
| Evaluation | Ionic conductivity @25 °C | | S/cm | 5.2E−04 | 1.9E−03 | 5.3E−04 | 5.6E−04 | 4.1E−04 | 2.0E−04 |
| results | Shape stability | | | Good | Good | Good | Good | Good | Good |
| (electrolyte) | | | | | | | | | |

| | Comparative | Comparative | Comparative | Comparative | Comparative |
|---|---|---|---|---|---|
| | Example | Example | Example | Example | Example |
| Example and Comparative Example Nos. | 6 | 7 | 8 | 9 | 10 |

| Curable | Component | (Meth)acrylic | BA | 2.2 | 14.9 | 14.0 | 10.5 | 4.5 |
|---|---|---|---|---|---|---|---|---|
| composition | (a) | monomer (parts) | HPP-A | 2.2 | 14.9 | 14.0 | 10.5 | 4.5 |
| for gel-like | | Total amount of | | 4.4 | 29.7 | 28.1 | 21.1 | 9.1 |
| electrolyte | | component (a) (parts) | | | | | | |
| | Component | Alkali metal salt | LiFSI | 14.4 | 31.8 | 4.4 | 46.6 | 42.4 |
| | (B) | (parts) | | | | | | |
| | Component | Nonaqueous organic | EC | 40.6 | 19.2 | 33.8 | 16.2 | 24.3 |
| | (C) | solvent | DEC | 40.6 | 19.2 | 33.8 | 16.2 | 24.3 |
| | | (parts) | | | | | | |
| | | Total amount of | | 81.2 | 38.5 | 67.5 | 32.3 | 48.6 |
| | | component (C) (parts) | | | | | | |
| | Other | Photopolymerization | HMP | 0.22 | 1.49 | 1.40 | 1.05 | 0.45 |
| | component | initiator | | | | | | |
| | | (parts) | | | | | | |
| | Molar concentration of | | | 0.32 | 2.11 | 1.99 | 1.50 | 0.64 |
| | (meth)acryloyl group (mol/kg) | | | | | | | |
| | Storage stability | | | Good | Good | Good | Good | Good |
| Evaluation | Ionic conductivity @25 °C | | S/cm | Unmeasurable | 1.5E−04 | 3.2E−04 | 1.7E−04 | 3.0E−04 |
| results | Shape stability | | | Poor | Good | Good | Good | Good |
| (electrolyte) | | | | | | | | |

TABLE 3

| | | | | Example | Example | Example | Example |
|---|---|---|---|---|---|---|---|
| Example and Comparative Example Nos. | | | | 16 | 17 | 18 | 19 |
| Curable | Component | (Meth)acrylic | GCA | 7.5 | 7.5 | 7.5 | |
| composition | (a) | monomer | BA | | | | 18 |
| for gel-like | | (parts) | HPP.A | 7.5 | 7.5 | 7.5 | 2.0 |
| electrolyte | | Total amount of component (a) (parts) | | 15 | 15 | 15 | 20 |
| | Component | Alkali metal | LiFSI | 10 | 15 | 20 | 30 |
| | (B) | salt (parts) | | | | | |
| | Component | Nonaqueous | PC | 75 | 70 | 65 | 50 |
| | (C) | organic | | | | | |
| | | solvent | | | | | |
| | | (parts) | | | | | |
| | Other | Photopoly- | TPO | 0.75 | 0.75 | 0.75 | 1.00 |
| | component | merization | | | | | |
| | | initiator | | | | | |
| | | (parts) | | | | | |
| | Molar concentration of | | | 0.80 | 0.80 | 0.80 | 1.28 |
| | (meth)acryloyl group (mol/kg) | | | | | | |
| | Storage stability | | | Good | Good | Good | Good |
| Evaluation | Ionic conductivity @25 °C | | S/cm | 2.7E−03 | 3.3E−03 | 2.1E−03 | 9.0E−04 |
| results | Shape stability | | | Good | Good | Good | Good |
| (electrolyte) | | | | | | | |

| | | | | | Comparative | Comparative |
|---|---|---|---|---|---|---|
| | | | | Example | Example | Example |
| Example and Comparative Example Nos. | | | | 20 | 11 | 12 |
| Curable | Component | (Meth)acrylic | GCA | | | |
| composition | (a) | monomer | BA | 18.9 | 14.4 | 13.5 |
| for gel-like | | (parts) | HPP.A | 2.1 | 1.6 | 1.5 |
| electrolyte | | Total amount of component (a) (parts) | | 21 | 16 | 15 |
| | Component | Alkali metal | LiFSI | 33 | 46 | 54 |
| | (B) | salt (parts) | | | | |
| | Component | Nonaqueous | PC | 46 | 38 | 31 |
| | (C) | organic | | | | |
| | | solvent | | | | |
| | | (parts) | | | | |
| | Other | Photopoly- | TPO | 1.05 | 0.80 | 0.75 |
| | component | merization | | | | |
| | | initiator | | | | |
| | | (parts) | | | | |
| | Molar concentration of | | | 1.33 | 1.06 | 1.00 |
| | (meth)acryloyl group (mol/kg) | | | | | |
| | Storage stability | | | Good | Good | Good |
| Evaluation | Ionic conductivity @25 °C | | S/cm | 6.6E−04 | 3.2E−04 | 1.9E−04 |
| results | Shape stability | | | Good | Good | Good |
| (electrolyte) | | | | | | |

TABLE 4

| | | | | Exam- | Exam- | Exam- | Exam- | Exam- |
|---|---|---|---|---|---|---|---|---|
| | | | | ple | ple | ple | ple | ple |
| Example No | | | | 21 | 22 | 23 | 24 | 25 |
| Curable | Component | (Meth)acrylic | BA | 17.1 | | | | |
| composition | (a) | monomer | HOA-MS (N) | | 17.1 | | | |
| for gel-like | | (parts) | AME-400 | | | 15.1 | | |
| electrolyte | | | FA1 | | | | 17.1 | |
| | | | FA2 | | | | | 17.1 |
| | | | HPP-A | 1.9 | 1.9 | 3.9 | 1.9 | 1.9 |
| | | Total amount of component (a) (parts) | | 19 | 19 | 19 | 19 | 19 |
| | Component | Alkali metal | LiFSI | 38 | 38 | 38 | 38 | 38 |
| | (B) | salt (parts) | | | | | | |
| | Component | Nonaqueous | PC | 43 | 43 | 43 | 43 | 43 |
| | (C) | organic | | | | | | |
| | | solvent | | | | | | |
| | | (parts) | | | | | | |
| | Other | Photopoly- | HMP | 0.95 | 0.95 | 0.95 | 0.95 | 0.95 |
| | component | merization | | | | | | |
| | | initiator | | | | | | |
| | | (parts) | | | | | | |
| | Molar concentration of (meth)acryloyl group (mol/kg) | | | 1.46 | 0.91 | 0.56 | 0.87 | 0.62 |
| | Storage stability | | | Good | Good | Fair | Good | Good |
| Evaluation | Ionic conductivity @25 °C | | S/cm | 1.2E−03 | 8.1E−04 | 1.5E−03 | 1.1E−03 | 1.1E−03 |
| results | Shape stability | | | Good | Good | Fair | Good | Good |
| (electrolyte) | | | | | | | | |

TABLE 5

| | | | | Exam- | Exam- | Exam- | Exam- |
|---|---|---|---|---|---|---|---|
| | | | | ple | ple | ple | ple |
| Example No. | | | | 26 | 27 | 28 | 29 |
| Curable | Component | (Meth)acrylic | BA | 7.5 | 7.5 | 7.5 | 7.5 |
| composition | (a) | monomer | GCA | | | | |
| for gel-like | | (parts) | HPP-A | 7.5 | 7.5 | 7.5 | 7.5 |
| electrolyte | | Total amount of | | 15 | 15 | 15 | 15 |
| | | component (a) (parts) | | | | | |
| | Component | Alkali metal salt | LiFSI | 20 | 20 | 20 | 20 |
| | (B) | (parts) | | | | | |
| | Component | Nonaqueous | EC | 32.5 | 19.5 | 6.5 | 32.5 |
| | (C) | organic | DEC | 32.5 | 45.5 | 58.5 | |
| | | solvent | DMC | | | | 32.5 |
| | | (parts) | VC | | | | |
| | | Total amount of component (C) (parts) | | 65 | 65 | 65 | 65 |
| | Other | Photopoly- | HMP | 0.75 | 0.75 | 0.75 | 0.75 |
| | component | merization | | | | | |
| | | initiator | | | | | |
| | | (parts) | | | | | |
| | Molar concentration of | | | 1.07 | 1.07 | 1.07 | 1.07 |
| | (meth)acryloyl group (mol/kg) | | | | | | |
| | Storage stability | | | Good | Good | Good | Good |
| Evaluation | Ionic conductivity @25 °C | | S/cm | 3.7E−03 | 3.0E−03 | 2.5E−03 | 4.0E−03 |
| results | Shape stability | | | Good | Good | Good | Good |
| (electrolyte) | | | | | | | |
| | | | | Exam- | Exam- | Exam- | Exam- |
| | | | | ple | ple | ple | ple |
| Example No. | | | | 30 | 31 | 54 | 55 |
| Curable | Component | (Meth)acrylic | BA | 7.5 | 7.5 | 7.5 | |
| composition | (a) | monomer | GCA | | | | 7.5 |
| for gel-like | | (parts) | HPP-A | 7.5 | 7.5 | 7.5 | 7.5 |
| electrolyte | | Total amount of | | 15 | 15 | 15 | 15 |
| | | component (a) (parts) | | | | | |
| | Component | Alkali metal salt | LiFSI | 20 | 20 | 20 | 20 |
| | (B) | (parts) | | | | | |
| | Component | Nonaqueous | EC | 19.5 | 6.5 | 19.5 | 19.5 |
| | (C) | organic | DEC | | | 45.5 | 45.5 |
| | | solvent | DMC | 45.5 | 58.5 | | |
| | | (parts) | VC | | | 1.0 | 1.0 |
| | | Total amount of component (C) (parts) | | 65 | 65 | 66 | 66 |
| | Other | Photopoly- | HMP | 0.75 | 0.75 | 0.75 | 0.75 |
| | component | merization | | | | | |
| | | initiator | | | | | |
| | | (parts) | | | | | |
| | Molar concentration of | | | 1.07 | 1.07 | 1.05 | 0.91 |
| | (meth)acryloyl group (mol/kg) | | | | | | |
| | Storage stability | | | Good | Good | Good | Good |
| Evaluation | Ionic conductivity @25 °C | | S/cm | 4.1E−03 | 2.6E−03 | 4.1E−03 | 3.6E−03 |
| results | Shape stability | | | Good | Good | Good | Good |
| (electrolyte) | | | | | | | |

TABLE 6

| | | | | Example | Example | Example | Example | Example | Example |
|---|---|---|---|---|---|---|---|---|---|
| Example and Comparative Example Nos. | | | | 32 | 33 | 34 | 35 | 36 | 37 |
| Curable | Component | (Meth)acrylic | GCA | | | | | | |
| composition | (a) | monomer (parts) | BA | 7.5 | 7.5 | 7.5 | 7.5 | 7.5 | 7.5 |
| for gel-like | | | HPP-A | 7.5 | 7.5 | 7.5 | 7.5 | 7.5 | 7.5 |
| electrolyte | | Total amount of component (a) (parts) | | 15 | 15 | 15 | 15 | 15 | 15 |
| | Component | Alkali metal salt | LiFSI | 20 | | | | | |
| | (B) | (parts) | LiFTFSI | | 30 | 20 | | | |
| | | | LiBETI | | | | 40 | 20 | |
| | | | NaFSI | | | | | | 20 |
| | | | KFSI | | | | | | |
| | Component | Nonaqueous organic | PC | 65 | 55 | 65 | 45 | 65 | 65 |
| | (C) | solvent | | | | | | | |
| | | (parts) | | | | | | | |
| | Other | Photopolymerization | HMP | 0.75 | 0.75 | 0.75 | 0.75 | 0.75 | 0.75 |
| | component | initiator | | | | | | | |
| | | (parts) | | | | | | | |
| | Molar concentration of | | | 1.07 | 1.07 | 1.07 | 1.07 | 1.07 | 1.07 |
| | (meth) acryloyl group (mol/kg) | | | | | | | | |
| | Storage stability | | | Good | Good | Good | Good | Good | Good |
| Evaluation | Ionic conductivity @25 °C | | S/cm | 3.2E-03 | 2.4E-03 | 2.6E-03 | 8.1E-04 | 1.6E-03 | 2.8E-03 |
| results | Shape stability | | | Good | Good | Good | Good | Good | Good |
| (electrolyte) | | | | | | | | | |

| | | | | | Comparative | Comparative | Comparative |
|---|---|---|---|---|---|---|---|
| | | | | Example | Example | Example | Example |
| Example and Comparative Example Nos. | | | | 38 | 13 | 14 | 15 |
| Curable | Component | (Meth)acrylic | GCA | | 9.0 | 9.0 | 9.0 |
| composition | (a) | monomer (parts) | BA | 7.5 | | | |
| for gel-like | | | HPP-A | 7.5 | 1.0 | 1.0 | 1.0 |
| electrolyte | | Total amount of component (a) (parts) | | 15 | 10 | 10 | 10 |
| | Component | Alkali metal salt | LiFSI | | 55 | | |
| | (B) | (parts) | LiFTFSI | | | | |
| | | | LiBETI | | | | |
| | | | NaFSI | | | 55 | |
| | | | KFSI | 20 | | | 55 |
| | Component | Nonaqueous organic | PC | 65 | 35 | 35 | 35 |
| | (C) | solvent | | | | | |
| | | (parts) | | | | | |
| | Other | Photopolymerization | HMP | 0.75 | 0.50 | 0.50 | 0.50 |
| | component | initiator | | | | | |
| | | (parts) | | | | | |
| | Molar concentration of | | | 1.07 | 0.59 | 0.59 | 0.59 |
| | (meth) acryloyl group (mol/kg) | | | | | | |
| | Storage stability | | | Good | Good | Good | Poor |
| Evaluation | Ionic conductivity @25 °C | | S/cm | 4.4E-03 | 2.5E-04 | 3.5E-04 | Unmeasurable |
| results | Shape stability | | | Good | Good | Good | Very poor |
| (electrolyte) | | | | | | | |

TABLE 7

| | | | | Compar- | Compar- | Compar- | Compar- | Compar- | Compar- | Compar- |
|---|---|---|---|---|---|---|---|---|---|---|
| | | | | ative | ative | ative | ative | ative | ative | ative |
| | | | | Exam- | Exam- | Exam- | Exam- | Exam- | Exam- | Exam- |
| | | | | ple | ple | ple | ple | ple | ple | ple |
| Comparative Example No. | | | | 16 | 17 | 18 | 19 | 20 | 21 | 22 |
| Curable | Component | (Meth)acrylic | MA | 20 | 15 | 10 | 7.5 | 10 | 5 | 5 |
| composition | (a) | monomer (parts) | HPP-A | 20 | 15 | 10 | 7.5 | 10 | 5 | 5 |
| for gel-like | | Total amount of | | 40 | 30 | 20 | 15 | 20 | 10 | 10 |
| electrolyte | | component (a) (parts) | | | | | | | | |
| | Component | Alkali metal salt | LiFSI | 60 | 70 | 80 | 80 | 70 | 80 | 70 |
| | (B) | (parts) | | | | | | | | |
| | Component | Nonaqueous organic | PC | | | | 5 | 10 | 10 | 20 |
| | (C) | solvent | | | | | | | | |
| | | (parts) | | | | | | | | |
| | Other | Photopolymerization | HMP | 2.00 | 1.50 | 1.00 | 0.75 | 1.00 | 0.50 | 0.50 |
| | component | initiator | | | | | | | | |
| | | (parts) | | | | | | | | |

| | Molar concentration of | | 3.60 | 2.70 | 1.80 | 1.35 | 1.80 | 0.90 | 0.90 |
|---|---|---|---|---|---|---|---|---|---|
| | (meth)acryloyl group (mol/kg) | | | | | | | | |
| | Storage stability | | Good | Good | Good | Good | Good | Good | Good |
| Evaluation | Ionic conductivity @25 °C | S/cm | 7.5E−09 | Unmea- | Unmea- | Unmea- | Unmea- | Unmea- | Unmea- |
| results | | | | surable | surable | surable | surable | surable | surable |

| | | | | | | | | |
|---|---|---|---|---|---|---|---|---|
| (electrolyte) | Shape stability | Good | Very poor | Very poor | Very poor | Very poor | Very poor | Very poor |

| | | | | Compar- | Compar- | Compar- | Compar- | Compar- | Compar- | Compar- |
|---|---|---|---|---|---|---|---|---|---|---|
| | | | | ative | ative | ative | ative | ative | ative | ative |
| | | | | Exam- | Exam- | Exam- | Exam- | Exam- | Exam- | Exam- |
| | | | | ple | ple | ple | ple | ple | ple | ple |
| Comparative Example No. | | | | 23 | 24 | 25 | 26 | 27 | 28 | 29 |
| Curable | Component | (Meth)acrylic | MA | 10 | 5 | 20 | 15 | 15 | 10 | 5 |
| composition | (a) | monomer (parts) | HPP-A | 10 | 5 | 20 | 15 | 15 | 10 | 5 |

| | | | | | | | | |
|---|---|---|---|---|---|---|---|---|
| for gel-like | Total amount of | 20 | 10 | 40 | 30 | 30 | 20 | 10 |
| electrolyte | component (a) (parts) | | | | | | | |

| | | | | | | | | | |
|---|---|---|---|---|---|---|---|---|---|
| Component | Alkali metal salt | LiFSI | 55 | 55 | 55 | 65 | 55 | 65 | 65 |
| (B) | (parts) | | | | | | | | |
| Component | Nonaqueous organic | PC | 25 | 35 | 5 | 5 | 15 | 15 | 25 |
| (C) | solvent | | | | | | | | |
| | (parts) | | | | | | | | |
| Other | Photopolymerization | HMP | 1.00 | 0.50 | 2.00 | 1.50 | 1.50 | 1.00 | 0.50 |
| component | initiator | | | | | | | | |
| | (parts) | | | | | | | | |

| | Molar concentration of | | 1.80 | 0.90 | 3.60 | 2.70 | 2.70 | 1.80 | 0.90 |
|---|---|---|---|---|---|---|---|---|---|
| | (meth)acryloyl group (mol/kg) | | | | | | | | |
| | Storage stability | | Good | Good | Good | Good | Good | Good | Good |
| Evaluation | Ionic conductivity @25 °C | S/cm | 4.1E−05 | 2.5E−04 | 2.8E−07 | 2.7E−07 | 2.1E−06 | 9.8E−06 | 8.6E−05 |

| | | | | | | | | |
|---|---|---|---|---|---|---|---|---|
| results | Shape stability | Good | Good | Good | Good | Good | Good | Good |
| (electrolyte) | | | | | | | | |

TABLE 8

| | | | | Example | Example | Example | Example | Example | Example |
|---|---|---|---|---|---|---|---|---|---|
| Example and Comparative Example Nos. | | | | 39 | 40 | 41 | 42 | 43 | 44 |
| Curable | Component | (Meth)acrylic | MA | 18.2 | | 21.1 | 16.8 | 13.2 | 14.4 |
| composition | (a) | monomer (parts) | HFP-A | | | | | 3.3 | 3.6 |
| for gel-like | | | M240 | 2.0 | 23.8 | 2.3 | 1.9 | | |
| electrolyte | | Total amount of | | 20.2 | 23.8 | 23.5 | 18.7 | 16.5 | 18.0 |
| | | component (a) (parts) | | | | | | | |
| | Component | Alkali metal salt | LiFSI | 30.3 | 35.6 | 26.4 | 28.0 | 21.5 | 20.0 |
| | (B) | (parts) | | | | | | | |
| | Component | Nonaqueous | PC | 49.5 | | | | | |
| | (C) | organic solvent | Acetonitrile | | 20.3 | | | | |
| | | (parts) | Succinonitrile | | 20.3 | 25.1 | 26.6 | | |
| | | | 3GL | | | | | 62.0 | 62.0 |
| | | | 4GL | | | 25.1 | 26.6 | | |
| | | Total amount of | | 49.5 | 40.7 | 50.1 | 53.3 | 62.0 | 62.0 |
| | | component (C) (parts) | | | | | | | |
| | Other | Photopolymerization | HMP | 1.01 | 1.19 | 1.17 | 0.94 | 0.83 | 0.90 |
| | component | initiator | | | | | | | |
| | | (parts) | | | | | | | |
| | Molar concentration of | | | 2.25 | 1.57 | 2.61 | 2.08 | 1.74 | 1.90 |
| | (meth)acryloyl group (mol/kg) | | | | | | | | |
| | Storage stability | | | Fair | Fair | Fair | Fair | Fair | Fair |
| Evaluation | Ionic conductivity @25 °C | | S/cm | 5.0E−04 | 5.2E−04 | 6.5E−04 | 6.7E−04 | 1.0E−03 | 1.1E−03 |
| results | Shape stability | | | Good | Good | Good | Good | Good | Good |
| (electrolyte) | | | | | | | | | |

| | | | | | Comparative | Comparative | Comparative |
|---|---|---|---|---|---|---|---|
| | | | | Example | Example | Example | Example |
| Example and Comparative Example Nos. | | | | 45 | 30 | 31 | 32 |
| Curable | Component | (Meth)acrylic | MA | 16.0 | 28.4 | 28.2 | |
| composition | (a) | monomer (parts) | HFP-A | 4.0 | | | |
| for gel-like | | | M240 | | 3.2 | 3.1 | 27.5 |
| electrolyte | | Total amount of | | 20.0 | 31.5 | 31.4 | 27.5 |
| | | component (a) (parts) | | | | | |
| | Component | Alkali metal salt | LiFSI | 15.0 | 23.6 | 35.2 | 41.1 |
| | (B) | (parts) | | | | | |
| | Component | Nonaqueous | PC | | | | |
| | (C) | organic solvent | Acetonitrile | | | | |
| | | (parts) | Succinonitrile | | | | |
| | | | 3GL | 65.0 | | | 31.4 |
| | | | 4GL | | 44.9 | 33.5 | |
| | | Total amount of | | 65.0 | 44.9 | 33.5 | 31.4 |
| | | component (C) (parts) | | | | | |
| | Other | Photopolymerization | HMP | 1.00 | 1.58 | 1.57 | 1.37 |
| | component | initiator | | | | | |
| | | (parts) | | | | | |
| | Molar concentration of | | | 2.11 | 3.51 | 3.48 | 1.82 |
| | (meth)acryloyl group (mol/kg) | | | | | | |
| | Storage stability | | | Fair | Poor | Poor | Poor |
| Evaluation | Ionic conductivity @25 °C | | S/cm | 1.2E−03 | 3.1E−04 | 7.0E−05 | 1.5E−04 |
| results | Shape stability | | | Good | Good | Good | Good |
| (electrolyte) | | | | | | | |

TABLE 9

| | | | | Exam- | Exam- | Exam- | Exam- | Exam- |
|---|---|---|---|---|---|---|---|---|
| | | | | ple | ple | ple | ple | ple |
| Example and Comparative Example Nos. | | | | 46 | 47 | 48 | 49 | 50 |
| Curable | Compo- | (Meth)acrylic | GCA | | | | | |
| compo- | nent | monomer | MA | 7.5 | | | | |
| sition | (a) | (parts) | EA | | 7.5 | | 7.5 | 7.5 |
| for gel-like | | | C-1 | | | 7.5 | | |
| electrolyte | | | HOA-MS | | | | | |
| | | | AME-400 | | | | | |
| | | | HPP-A | 7.5 | 7.5 | 7.5 | 7.5 | 7.5 |
| | | Total amount of component (a) (parts) | | 15.0 | 15.0 | 15.0 | 15.0 | 15.0 |
| | Compo- | Alkali metal | LiFSI | 20.0 | | 20.0 | 20.0 | 20.0 |
| | nent | salt (parts) | | | | | | |
| | (B) | | LiTFSI | | 20.0 | | | |
| | Compo- | Nonaqueous | PC | 65.0 | 65.0 | 65.0 | | |
| | nent | organic solvent | 2GL | | | | | |
| | (C) | (parts) | SGL | | | | | |
| | | | 4GL | | | | | |
| | | | Acetonitrile | | | | 32.5 | |
| | | | Succinonitnie | | | | 32.5 | |
| | | | Acetylacetone | | | | | 65.0 |
| | | | Dimethyl | | | | | |
| | | | succinate | | | | | |
| | | | Dimethyl | | | | | |
| | | | adipate | | | | | |
| | | | Ethyl acetate | | | | | |
| | | Total amount of component (C) (parts) | | 65.0 | 65.0 | 65.0 | 65.0 | 65.0 |
| | Other | Photopoly- | HMP | 0.75 | 0.75 | 0.75 | 0.75 | 0.75 |
| | component | merization | | | | | | |
| | | initiator | | | | | | |
| | | (parts) | | | | | | |
| | Molar concentration of | | | 1.35 | 1.23 | 1.06 | 1.23 | 1.23 |
| | (meth)acryloyl group (mol/kg) | | | | | | | |
| | Storage stability | | | Good | Good | Fair | Fair | Good |
| Evaluation | Ionic conductivity @25 °C | | S/cm | 4.2E−03 | 2.8E−03 | 4.5E−03 | 4.8E−03 | 3.7E−03 |
| results | Shape stability | | | Good | Good | Good | Good | Good |
| (electrolyte) | | | | | | | | |
| | | | | | | | Com- | Com- |
| | | | | | | | par- | par- |
| | | | | | | | ative | ative |
| | | | | Exam- | Exam- | Exam- | Exam- | Exam- |
| | | | | ple | ple | ple | ple | ple |
| Example and Comparative Example Nos. | | | | 51 | 52 | 53 | 33 | 34 |
| Curable | Compo- | (Meth)acrylic | GCA | | | | | |
| compo- | nent | monomer | MA | | | | 28.8 | |
| sition | (a) | (parts) | EA | 7.5 | 7.5 | 7.5 | | 26.1 |
| for gel-like | | | C-1 | | | | | |
| electrolyte | | | HOA-MS | | | | | |
| | | | AME-400 | | | | | |
| | | | HPP-A | 7.5 | 7.5 | 7.5 | 1.5 | 1.4 |
| | | Total amount of component (a) (parts) | | 15.0 | 15.0 | 15.0 | 30.3 | 27.5 |
| | Compo- | Alkali metal | LiFSI | 20.0 | 20.0 | 20.0 | 45.4 | 41.1 |
| | nent | salt (parts) | | | | | | |
| | (B) | | LiTFSI | | | | | |
| | Compo- | Nonaqueous | PC | | | | 24.3 | |
| | nent | organic solvent | 2GL | | | | | |
| | (C) | (parts) | 3GL | | | | | |
| | | | 4GL | | | | | |
| | | | Acetonitrile | | | | | |
| | | | Succinonitnie | | | | | |
| | | | Acetylacetone | | | | | |
| | | | Dimethyl | 65.00 | | | | 31.5 |
| | | | succinate | | | | | |
| | | | Dimethyl | | 65.0 | | | |
| | | | adipate | | | | | |
| | | | Ethyl acetate | | | 65.0 | | |
| | | Total amount of component (C) (parts) | | 65.0 | 65.0 | 65.0 | 24.3 | 31.5 |
| | Other | Photopoly- | HMP | 0.75 | 0.75 | 0.75 | 1.52 | 1.37 |
| | component | merization | | | | | | |
| | | initiator | | | | | | |
| | | (parts) | | | | | | |
| | Molar concentration of | | | 1.23 | 1.23 | 1.23 | 3.44 | 2.69 |
| | (meth)acryloyl group (mol/kg) | | | | | | | |
| | Storage stability | | | Good | Good | Good | Good | Good |
| Evaluation | Ionic conductivity @25 °C | | S/cm | 2.5E−03 | 1.9E−03 | 4.8E−03 | 1.5E−05 | 6.6E−05 |
| results | Shape stability | | | Good | Good | Good | Good | Good |
| (electrolyte) | | | | | | | | |
| | | | | Com- | Com- | Com- | Com- | Com- |
| | | | | par- | par- | par- | par- | par- |
| | | | | ative | ative | ative | ative | ative |
| | | | | Exam- | Exam- | Exam- | Exam- | Exam- |
| | | | | ple | ple | ple | ple | ple |
| Example and Comparative Example Nos. | | | | 35 | 36 | 37 | 38 | 39 |
| Curable | Compo- | (Meth)acrylic | GCA | | | 14.9 | | |
| compo- | nent | monomer | MA | | 13.0 | 14.9 | 14.5 | |
| sition | (a) | (parts) | EA | | | | | 26.8 |
| for gel-like | | | C-1 | 28.8 | | | | |
| electrolyte | | | HOA-MS | | | | 14.5 | |
| | | | AME-400 | | 13.0 | | | |
| | | | HPP-A | 1.5 | 1.4 | 1.6 | 1.5 | 1.4 |
| | | Total amount of component (a) (parts) | | 30.3 | 27.5 | 31.4 | 30.5 | 28.2 |
| | Compo- | Alkali metal | LiFSI | 45.4 | 41.1 | 46.9 | 45.6 | 42.2 |
| | nent | salt (parts) | | | | | | |
| | (B) | | LiTFSI | | | | | |
| | Compo- | Nonaqueous | PC | 24.3 | | | | |
| | nent | organic solvent | 2GL | | | | | 28.7 |
| | (C) | (parts) | 3GL | | | | | |
| | | | 4GL | | | | | |
| | | | Acetonitrile | | | | | |
| | | | Succinonitnie | | | | | |
| | | | Acetylacetone | | | | 23.9 | |
| | | | Dimethyl | | 31.5 | | | |
| | | | succinate | | | | | |
| | | | Dimethyl | | | | | |
| | | | adipate | | | | | |
| | | | Ethyl acetate | | | 21.7 | | |
| | | Total amount of component (C) (parts) | | 24.3 | 31.5 | 21.7 | 23.9 | 29.7 |
| | Other | Photopoly- | HMP | 1.52 | 1.37 | 1.57 | 1.52 | 1.41 |
| | component | merization | | | | | | |
| | | initiator | | | | | | |
| | | (parts) | | | | | | |
| | Molar concentration of | | | 2.31 | 1.87 | 1.83 | 2.45 | 2.76 |
| | (meth)acryloyl group (mol/kg) | | | | | | | |
| | Storage stability | | | Fair | Fair | Good | Good | Fair |
| Evaluation | Ionic conductivity @25 °C | | S/cm | 1.8E−05 | 1.4E−05 | 1.8E−04 | 1.2E−04 | 1.1E−04 |
| results | Shape stability | | | Good | Good | Good | Good | Good |
| (electrolyte) | | | | | | | | |

Details of the compounds used in Tables 1 to 9 are shown below.
GCA: purified product containing (2-oxo-1,3-dioxolane-4-yl) methyl acrylate obtained in Synthesis Example 1
MA: methyl acrylate [manufactured by Toagosei Co., Ltd.]
EA: ethyl acrylate [manufactured by Toagosei Co., Ltd.]
BA: n-butyl acrylate [manufactured by Toagosei Co., Ltd.]
C-1: 2-methoxyethyl acrylate [Acrycs (registered trademark) C-1 manufactured by Toagosei Co., Ltd.]
HOA-MS (N): 2-acryloyloxyethyl-succinic acid [HOA-MS (N) manufactured by Kyoeisha Chemical Co., Ltd.]
AME-400: methoxypolyethylene glycol acrylate, repeat number of oxyethylene: about 9 [Blemmer (registered trademark) AME-400 manufactured by NOF Corporation]
FA-1: unsaturated fatty acid hydroxyalkyl ester-modified ε-caprolactone, polycaprolactone average repeat number: 1 [Placcel FA-1DDM manufactured by Daicel Corporation]
FA-2: unsaturated fatty acid hydroxyalkyl ester-modified s-caprolactone, polycaprolactone average repeat number: 2[Placcel FA-2D manufactured by Daicel Corporation]
HPP-A: hydroxypivalic acid neopentyl glycol acrylic acid adduct (Light Acrylate HPP-A manufactured by Kyoeisha Chemical Co., Ltd.: In the above formula (2), m and n are both 0, and R¹ and R² are both a hydrogen atom. Y is an alkylene group having two carbon atoms (ethylene group), and has methyl groups at the 2,2 positions as viewed from the acryloyl group side to which the ethylene group is bonded. Z is an alkylene group having three carbon atoms (propylene group), and has methyl groups at the 2,2 positions.)
M240: polyethylene glycol diacrylate (n≈4) (Aronix (registered trademark) M-240 manufactured by Toagosei Co., Ltd.)
LiFSI: lithium bis(fluorosulfonyl)imide [manufactured by FUJIFILM Wako Pure Chemical Corporation]
LiTFSI: lithium bis(trifluoromethanesulfonyl)imide [manufactured by FUJIFILM Wako Pure Chemical Corporation]
LiBETI: lithium bis(perfluoroethylsulfonyl)imide [manufactured by FUJIFILM Wako Pure Chemical Corporation]
NaFSI: sodium bis(fluorosulfonyl)imide [manufactured by FUJIFILM Wako Pure Chemical Corporation]
KFSI: potassium bis(fluorosulfonyl)imide [manufactured by FUJIFILM Wako Pure Chemical Corporation]
PC: propylene carbonate [manufactured by FUJIFILM Wako Pure Chemical Corporation]
EC: ethylene carbonate [manufactured by FUJIFILM Wako Pure Chemical Corporation]
DEC: diethyl carbonate [manufactured by Tokyo Chemical Industry Co., Ltd.]
DMC: dimethyl carbonate [manufactured by Tokyo Chemical Industry Co., Ltd.]
VC: vinylene carbonate [manufactured by Tokyo Chemical Industry Co., Ltd.]
2GL: diglyme [manufactured by Tokyo Chemical Industry Co., Ltd.]
3GL: triethylene glycol dimethyl ether [manufactured by Tokyo Chemical Industry Co., Ltd.]
4GL: tetraethylene glycol dimethyl ether [manufactured by Tokyo Chemical Industry Co., Ltd.]
HMP: 2-hydroxy-2-methylpropiophenone [manufactured by Tokyo Chemical Industry Co., Ltd.]
TPO: diphenyl(2,4,6-trimethylbenzoyl)phosphine oxide [Omirad TPO H manufactured by IGM Resins]

### Example 56

A gel-like electrolyte was obtained by the same operation as in Example 54 except that the photopolymerization initiator was changed to a thermal polymerization initiator (0.15 part by mass of 2,2′-azobis(2-methylbutyronitrile) (ABN-E manufactured by Japan Finechem Company. Inc.) with respect to 100 parts by mass of the total amount of the component (a)) to prepare a curable composition for a gel-like electrolyte, and thermal curing (left to stand in an oven at 60 °C for 48 hours) was performed. The reaction rate of the component (a) was >96%.

In the process of preparing the curable composition for a gel-like electrolyte, ABN-E was added and dissolved in a state where the temperature of a solution containing the component (a), the component (B), and the component (C) uniformly dissolved reached room temperature.

As a result of measuring the ionic conductivity of the obtained gel-like electrolyte, the ionic conductivity was 4.1×10⁻³ S/cm, and the shape stability was Good. The storage stability was evaluated in a state where the thermal polymerization initiator was not added, and the stability was Good.

### Example 571

A gel-like electrolyte was obtained by the same operation as in Example 55 except that the photopolymerization initiator was changed to a thermal polymerization initiator (0.15 part by mass of 2,2′-azobis(2-methylbutyronitrile) (ABN-E manufactured by Japan Finechem Company, Inc.) with respect to 100 parts by mass of the total amount of the component (a)) to prepare a curable composition for a gel-like electrolyte, and thermal curing (left to stand in an oven at 60 °C for 48 hours) was performed. The reaction rate of the component (a) was >96%.

In the process of preparing the curable composition for a gel-like electrolyte, ABN-E was added and dissolved in a state where the temperature of a solution containing the component (a), the component (B), and the component (C) uniformly dissolved reached room temperature.

As a result of measuring the ionic conductivity of the obtained gel-like electrolyte, the ionic conductivity was 3.6×10³ S/cm, and the shape stability was Good. The storage stability was evaluated in a state where the thermal polymerization initiator was not added, and the stability was Good.

### <<Preparation of Negative Electrode Plate>>

As the active material, artificial graphite (trade name “SCMG-CF” manufactured by Showa Denko K.K) and SiO (5 μm manufactured by OSAKA Titanium technologies Co., Ltd.) were used. As the binder, a mixture of styrene/butadiene-based latex (SBR) and carboxymethyl cellulose (CMC) was used. Artificial graphite: SiO:SBR:CMC=77.6:19.4:3.0:1.0 (solid content) in a mass ratio was mixed with water as a diluent solvent using a planetary mixer (HIVIS MIX 2P-03 type manufactured by PRIMIX Corporation) to prepare a negative electrode mixture slurry having a solid content of 50%. The negative electrode mixture slurry was applied to one surface of a copper foil (thickness: 16.5 μm) and dried to form a mixture layer. Thereafter, the mixture layer was rolled such that the thickness of the mixture layer per one surface was 50 t 5 μm and the mixture density was 1.60 f 0.10 g/cm³, and then punched into a 3 cm square to obtain a negative electrode plate.

### (Preparation of Positive Electrode Plate)

In an N-methylpyrrolidone (NMP) solvent, NMC532 (LiNi_{0.5}Mn_{0.3}Co_{0.2}O₂) as a positive electrode active material, acetylene black as a carbon conductive agent, and polyvinylidene fluoride (PVDF) having an average molecular weight of 1.1 million were mixed at a mass ratio of 100:2:4 using a mixer in the same manner as in the negative electrode to prepare a positive electrode mixture slurry having a solid content of 50%. The prepared slurry was applied to one surface of an aluminum foil (thickness: 20 μm), dried, rolled such that the mixture layer had a thickness per one surface of 125 μm and a packing density of 3 g/cm³, and then punched into a 3 cm square to obtain a positive electrode plate.

### <<Preparation of Battery>>

The configuration of the battery was as follows. A positive electrode and a negative electrode each having a lead terminal attached thereto were used. A separator (polyethylene, film thickness: 20 μm, porosity 48%, manufactured by Shenzhen Senior Technology Material Co., Ltd. of China) was sandwiched between both electrodes with mixture layers of both electrodes facing the separator side. The product was placed in a battery package using an aluminum laminate. The curable composition for a gel-like electrolyte prepared in each of Examples 56 and 57 was injected in the battery package, and sealed by heat sealing. Then the resultant product was left to stand at 25 °C for 24 hours to promote permeation of the curable composition into the electrodes.

Thereafter, the resultant product was left to stand in a thermostatic chamber at 60 °C for 48 hours to polymerize the component (a) to prepare a test battery (pouch type battery).

The designed capacity of the battery is 49 mAh. As the designed capacity of the battery, the battery was designed based on an end-of-charge voltage up to 4.2 V.

### <Charge-Discharge Test>

The prepared pouch type battery was set in a thermostatic chamber at 45 °C, and a charge-discharge test (charge-discharge tester VMP-3 manufactured by BioLogic Corporation of France) was performed. In the first charge-discharge, CC charging was performed at 4.9 mA corresponding to a rate of 0.1 C with respect to 49 mAh, and switching to CV charging was performed after reaching 4.2 V. When the current value decreased to 0.49 mA, charging was stopped, and the battery was left to stand for 48 hours to promote the formation of SEI. Thereafter, the battery was discharged to a final voltage of 2.5 V at 0.1 C. In the second charge-discharge, charging and discharging were performed with a capacity set to 40 mAh in consideration of the irreversible capacity and with a current value of 4 mA (corresponding to 0.1 C) during constant current charging and discharging.

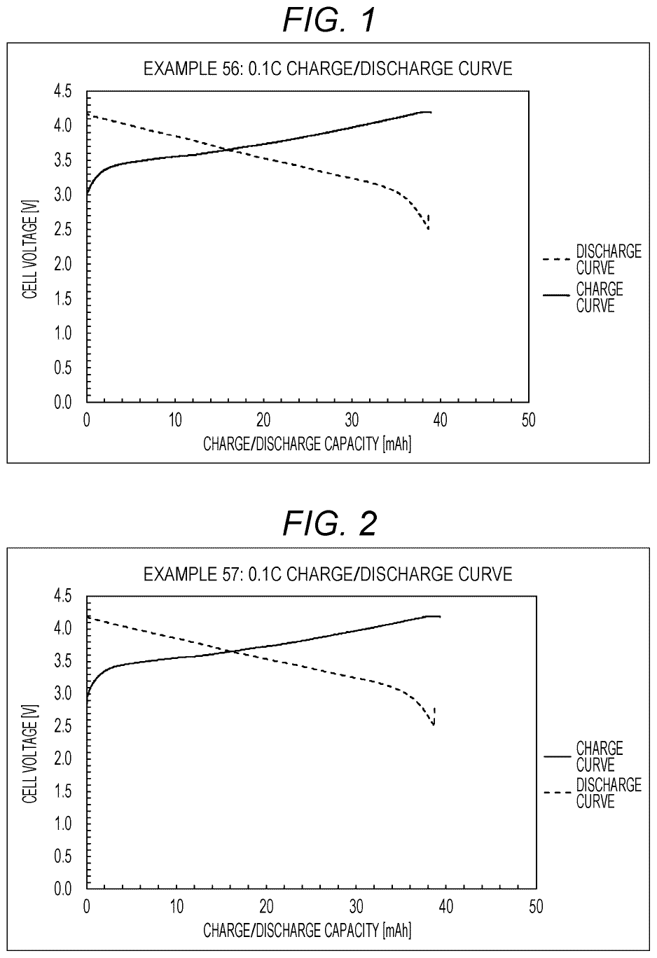

The charging was switched to CV charging after CC charging to 4.2 V was performed, and the charging was stopped when the current value decreased to 0.4 mA. After being left for 30 minutes, the battery was discharged at 0.1 C under the condition of an end voltage of 2.5 V. The second charge/discharge curves are shown in FIG. 1 (Example 56) and FIG. 2 (Example 57).

### 3. Evaluation Results

As is apparent from the results of Examples 1 to 57, the gel-like electrolyte of the present invention exhibited high ionic conductivity (5.0×10⁻⁴ or more as a value of ionic conductivity at 25 °C) even at room temperature (25 °C), and had excellent shape stability. Among them, Examples (other than Examples 24 and 39 to 42) in which the oxygen atom constituting the component (A) (component (a)) did not substantially contain an oxygen atom derived from an ether group and Examples (other than Examples 41 to 45) in which the oxygen atom constituting the component (C) did not substantially contain an oxygen atom derived from an ether group had results further excellent in storage stability of the curable composition. In addition, as is apparent from the results of Examples 56 and 57, a discharge capacity of 95% or more with respect to a target charge amount of 40 mAh was obtained, and good charge/discharge characteristics were exhibited.

On the other hand, in Comparative Examples 1 to 39 in which any of the contents of the component (A) (component (a)), the component (B), and the component (C) did not satisfy the specific matters of the present invention, the value of the ionic conductivity at 25 °C was less than 5.0-10⁻⁴, which was not a practical level as a gel-like electrolyte.

1. A gel-like electrolyte comprising: a (meth)acrylic polymer (hereinafter, referred to as “component (A)”) having a structural unit derived from a (meth)acrylic monomer containing a compound having two or more (meth)acryloyl groups; an alkali metal salt (hereinafter, referred to as “component (B)”); and a nonaqueous organic solvent (hereinafter, referred to as “component (C)”),
wherein a content ratio of the components (A) to (C) with respect to 100 mass % of a total of the components (A) to (C) is 10 to 30 mass % for the component (A), 5 to 40 mass % for the component (B), and 40 to 80 mass % for the component (C).

2. The gel-like electrolyte according to claim 1, wherein an oxygen atom constituting the component (A) does not substantially contain an oxygen atom derived from an ether group.

3. The gel-like electrolyte according to claim 1, wherein an oxygen atom constituting the component (C) does not substantially contain an oxygen atom derived from an ether group.

4. The gel-like electrolyte according to claim 1, wherein the component (B) includes an alkali metal salt having a disulfonimide structure represented by formula (1) below:
Rf₁—S(═O)₂N⁻S(═O)₂Rf₂M⁺ (1)
(Rf₁ and Rf₂ are the same or different and represent a fluorine atom or a perfluoroalkyl group, the perfluoroalkyl groups may form a cyclic structure with each other by a covalent bond, and M⁺ represents a lithium ion, a sodium ion, or a potassium ion).

5. The gel-like electrolyte according to claim 3, wherein the component (C) includes at least one selected from the group consisting of a carbonate compound, an aliphatic ester compound, and a nitrile compound.

6. The gel-like electrolyte according to claim 1, wherein the compound having two or more (meth)acryloyl groups includes a compound represented by formula (2) below: 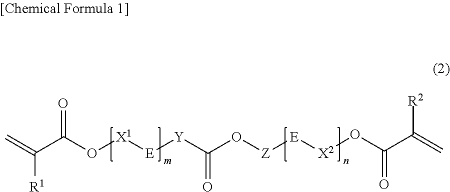
(R¹ and R² each independently represent a hydrogen atom or a methyl group, X¹, X², Y, and Z each independently represent an alkylene group having 2 to 6 carbon atoms which may have a substituent, E represents an ester bond, and m and n each independently represent 0 to 5).

7. A curable composition used for producing a gel-like electrolyte, the curable composition comprising:
a (meth)acrylic monomer (hereinafter, referred to as “component (a)”) containing a compound having two or more (meth)acryloyl groups; an alkali metal salt (hereinafter, referred to as “component (B)”; and a nonaqueous organic solvent (hereinafter, referred to as component (C)),
wherein a content ratio of the component (a), the component (B), and the component (C) with respect to 100 mass % of a total of the component (a), the component (B), and the component (C) is 10 to 30 mass % for the component (a), 5 to 40 mass % for the component (B), and 40 to 80 mass % for the component (C).

8. The curable composition according to claim 7, wherein an oxygen atom constituting the component (a) does not substantially contain an oxygen atom derived from an ether group.

9. The curable composition according to claim 7, wherein an oxygen atom constituting the component (C) does not substantially contain an oxygen atom derived from an ether group.

10. The curable composition according to claim 7, wherein the component (B) includes an alkali metal salt having a disulfonimide structure represented by formula (1) below:
Rf₁—S(═O)₂N⁻S(═O)₂Rf₂M⁺ (1)
(Rf₁ and Rf₂ are the same or different and represent a fluorine atom or a perfluoroalkyl group, the perfluoroalkyl groups may form a cyclic structure with each other by a covalent bond, and M⁺ represents a lithium ion, a sodium ion, or a potassium ion).

11. The curable composition according to claim 9, wherein the component (C) includes at least one selected from the group consisting of a carbonate compound, an aliphatic ester compound, and a nitrile compound.

12. The curable composition according to claim 7, wherein the compound having two or more (meth)acryloyl groups includes a compound represented by formula (2) below: 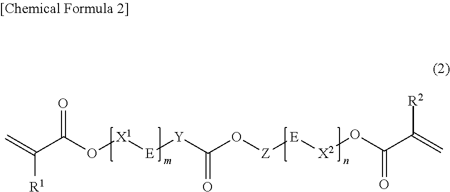
(R¹ and R² each independently represent a hydrogen atom or a methyl group, X¹, X², Y, and Z each independently represent an alkylene group having 2 to 6 carbon atoms which may have a substituent, E represents an ester bond, and m and n each independently represent 0 to 5).

13. A gel-like electrolyte which is a cured product of the composition according to claim 7.

14. A power storage device comprising the gel-like electrolyte according to claim 1.

15. A power storage device comprising the gel-like electrolyte according to claim 13.
